(19) United States
(12) Patent Application Publication
(10) Pub. No.: US 2007/0072954 A1
(43) Pub. Date: Mar. 29, 2007

(54) Novel tetraoxaspiroalkanes and methods of use with organosilicon monomers in polyerizable compositions

(75) Inventors: Cecil C. Chappelow, Leawood, KS (US); Charles S. Pinzino, Kansas City, MO (US); Shin-Shi Chen, Overland Park, KS (US); J. David Eick, Gladstone, MO (US)

Correspondence Address: STINSON MORRISON HECKER LLP;ATTN: PATENT GROUP, 1201 WALNUT STREET, SUITE 2800, KANSAS CITY, MO, 64106-2150, US

(73) Assignees: Curators of the University of Missouri; Midwest Research Institute

(21) Appl. No.: 11/540,031

(22) Filed: Sep. 29, 2006

Related U.S. Application Data
(60) Provisional application No. 60/721,806, filed on Sep. 29, 2005.

(51) Int. Cl. C08F 2/50

(52) U.S. Cl. 522/6

(57) ABSTRACT

This invention relates to compositions of matter that include a polymerization stress reducing monomer, which may be one of the novel tetraoxaspiroalkanes disclosed herein, and an organosilicon monomer, such as a silorane. These matrix resin compositions may also include a photoinitiator, a photosensitizer, a reaction promoter, and other additives. The photopolymerizable compositions of this invention are useful for a variety of applications including use as dental matrix resin systems, such as restorative composites.

### CROSS-REFERENCE TO RELATED APPLICATIONS

The present application claims priority to U.S. Provisional Patent Application No. 60/721,806 filed on Sep. 29, 2005, which is incorporated by reference.

### STATEMENT REGARDING FEDERALLY SPONSORED RESEARCH

The present invention was sponsored in part by National Institutes of Health and National Institute of Dental and Crainofacial Research Grant No. DE09696, and the government may have certain rights in the invention.

### BACKGROUND OF THE INVENTION

1. Field of the Invention

This invention relates in general to compositions of matter and, more particularly, to compositions that include tetraoxaspiro[5.5]undecanes (“TOSU”) and organosilicon monomers, such as silorane monomers. These compositions may also include a photoinitiator, a photosensitizer, and/or a reaction promoter. The polymerizable compositions of the present invention are useful for a variety of applications, including use as dental materials, such as composites. Novel TOSUs, including those with a silicon-containing moiety, are provided.

2. Description of Related Art

Many types of monomers undergo shrinkage during polymerization to a degree that makes them generally unsuited for use in numerous applications, including for use as stress-free composites, high-strength adhesives, and precision castings. As an example, when such monomers are used in composites that contain inorganic fillers, the polymeric matrix is subject to failure when the polymer shrinks and pulls away from the filler particles. Failure of the composite can also occur when the matrix ruptures as a result of voids or micro cracks which form in the matrix during polymerization shrinkage.

Polymeric restorative dentistry has been dominated by free radical methacrylate-based chemistry for over 50 years. More recently, a variety of organosilicon compounds with oxirane functionality were first synthesized and polymerized by Sato et al., JP Patent No. 51033541 (Sep. 20, 1976). Similar compounds were studied by Crivello and others. See Crivello et al., European Patent No. 574264 (1993); Crivello et al., European Patent No. 412430 (1991). More recently, “silorane” monomers, which refers to monomers containing both oxirane and siloxane moieties, have been polymerized via cationic initiation for applications in dentistry. Metal halide salts of complex arylonium cations, which efficiently generate protons upon irradiation, initiate the polymerization. In order for these initiators to function in a dental system using visible light, they also usually contain a photosensitizer, such as camphorquinone (“CQ”). Also, addition of ethyl 4-dimethylaminobenzoate (“EDMAB”) and similar compounds to the photoinitiator system greatly enhance the photoreactivity of oxirane resin systems.

Various TOSU monomers have the potential to reduce polymerization shrinkage and stress in dioxirane/polyol photocationic dental resins systems. See Chappelow et al., U.S. Pat. No. 6,825,364; Chappelow et al., U.S. Pat. No. 6,653,486; and Chappelow et al., U.S. Pat. No. 6,658,865, which are incorporated by reference. In the present invention, it is demonstrated that TOSUs can also improve polymerization stress in organosilicon systems, such as silorane-based systems. Further, novel tetraoxaspirocyclic monomers, including those containing a silicon functionality, were prepared for use in conjunction with silorane-based systems.

### BRIEF SUMMARY OF THE INVENTION

The present invention is directed to a visible light cationically photopolymerizable composition. The composition includes an organosilicon monomer, such as a silorane, and a compatible TOSU monomer. More specifically, the compatible TOSU monomer used in this composition is one or more novel tetraoxaspiro[5.5]undecanes, such as those having a silicon-containing moiety. The composition of the present invention may be used as a matrix resin for dental restorative materials. Still further, as another embodiment of the present invention, various novel tetraoxaspiro[5.5]undecanes are provided.

In one aspect, the present invention is directed to a copolymer system derived by polymerizing organosilicon monomers (e.g. siloranes) and TOSUs. The resulting copolymer composition possesses the mechanical and physical properties necessary to allow the composition to be used as a composite material, including as a dental composite matrix. Other uses of the composition are as a bone cement for bone fractures, cementing implants, and bone trauma.

In another aspect, the copolymer compositions having the TOSUs of the present invention exhibit less polymerization stress containing the organosilicon monomers alone.

It is another object of this invention to provide a dental composite having a tensile strength and modulus of elasticity comparable with that of conventional dental composites but having negligible shrinkage during polymerization so that the cured composite is less likely to fail.

Additional aspects of the invention, together with the advantages and novel features appurtenant thereto, will be set forth in part in the description that follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 shows the photoreactivity exotherm profiles for SIL-MIX with 0 (top) 10 (middle) and 25 (bottom) wt % of 6 (DEBTMSPOM-1,5,7,11-TOSU).

FIG. 2 shows selected FTIR spectral regions of an equimolar SIL-MIX and 6 (DEBFMSPOM-1,5,7,11-TOSU) mixture before and after visible light irradiation for 10 minutes as a thin film on a salt plate.

FIG. 3 shows the ¹³C NMR spectra of 6 (DEBTMSPOM-1,5,7,11-TOSU) after 20 minutes visible light irradiation with 0 hour dark cure (top) and 24 hour dark cure (bottom).

FIG. 4 shows the FTIR spectra of 6 (DEBTMSPOM-1,5,7,11-TOSU) after 20 minutes visible light irradiation with 0 hour dark cure (top) and 24 hour dark cure (bottom) post ¹³C NMR analysis

FIG. 5 shows the photopolymerization stress (white bars; mean of 3 replicates) for SIL-MIX formulations compared to a conventional BIS-GMA/TEGDMA (BT) resin. Shaded bars (debond strength) are shown to demonstrate that there was sufficient bonding for the tests to be successfully completed. Stress bars with the same letter are not significantly different.

### DETAILED DESCRIPTION OF PREFERRED EMBODIMENT

Molecular terms, when used in this application, have their common meaning unless otherwise specified. It should be noted that the alphabetical letters used in the formulas of the present invention should be interpreted as the functional groups, moieties, or substituents as defined herein. Unless otherwise defined, the symbols will have their ordinary and customary meaning to those skilled in the art.

The term “alkyl” embraces a branched or unbranched saturated hydrocarbon group of 1 to 12 carbon atoms, such as methyl, ethyl, n-propyl, isopropyl, n-butyl, isobutyl, t-butyl, octyl, decyl, tetradecyl, as well as cyclic alkyl groups and the like.

The term “alkoxy” embraces an alkyl group attached to an oxygen. Examples include, without limitation, methoxy, ethoxy, tert-butoxy, and cyclohexyloxy. Most preferred are “lower alkoxy” groups having one to six carbon atoms. Examples of such groups include methoxy, ethoxy, propoxy, butoxy, isopropoxy, and tert-butoxy groups.

The term “alkenyl” embraces unsaturated aliphatic groups analogous in length and possible substitution to the alkyls described above, but that contain at least one double bond. Examples include propenyl, 1-butenyl, 2-butenyl, 3-butenyl, 2-methylpropenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, and the like.

The term “alkenoxy” embraces an alkenyl group attached to an oxygen Examples include allyloxy, 1-propenyloxy, isopropenyloxy, methallyloxy, 2-butenyloxy, 1-butenyloxy, isobutyloxy, pentenyloxy, hexenyloxy, octenyloxy, or decenyloxy.

The term “alkenoxyalkyl” embraces an alkenoxy-substituted alkyl moiety. Examples include allyloxymethyl, allyloxyethyl, allyloxypropyl, and methallyoxymethyl.

The term “aryl” embraces a carbocyclic aromatic system containing one, two, or three rings wherein such rings may be attached together in a pendant manner or may be fused. The term “fused” means that a second ring is present (i.e., attached or formed) by having two adjacent atoms in common (i.e., shared) with the first ring. The term “fused” is equivalent to the term “condensed.” The term “aryl” embraces aromatic groups such as phenyl, naphthyl, tetrahydronaphthyl, indane, and biphenyl.

The term “arylalkyl” or “aralkyl” embrace aryl-substituted alkyl moieties. Preferable aralkyl groups are “lower aralkyl” groups having aryl groups attached to alkyl groups having one to six carbon atoms. Examples of such groups include benzyl, diphenylmethyl, triphenylmethyl, phenylethyl, and diphenylethyl. The terms benzyl and phenylmethyl are interchangeable.

The term “aryloxy” embraces aryl groups, as defined above, attached to an oxygen atom, such as phenoxy.

The term “aralkoxy” or “arylalkoxy” embrace aralkyl groups attached through an oxygen atom to other groups. “Lower aralkoxy” groups are those phenyl groups attached to lower alkoxy group as described herein. Examples of such groups include benzyloxy, 1-phenylethoxy, 3-trifluoromethoxybenzyloxy, 4-propylbenzyloxy, and 2-phenylethoxy.

The term silyl refers to the group —SiH₃. The silyl group may be optionally substituted with one or more alkyl, aryl, arylalkyl, alkoxy, aryloxy, arylalkoxy groups, or combinations thereof. Thus, for example, the term “alkylsilyl” embraces a silyl group substituted with one or more alkyl groups, such as methylsilyl, dimethylsilyl, trimethylsilyl, ethylsilyl, diethysilyl, triethylsilyl, and the like. The term “arylsilyl” similarly refers to a silyl group substituted with one or more aryl groups, such as phenylsilyl. The term “arylalkylsilyl” refers to a silyl group substituted with one or more arylalkyl groups. The term alkoxysilyl refers to a silyl group substituted with one or more alkoxy groups. The term “aryloxysilyl” embraces silyl groups substituted with one or more aryloxy groups. The term “arylalkoxysilyl” embraces silyl groups substituted with one or more arylalkoxy groups.

The term “siloxy” embraces oxy-containing groups substituted with a silyl group. The siloxy group may be optionally substituted with one or more alkyl, aryl, arylalkyl, alkoxy, aryloxy, arylalkoxy groups, or combinations thereof. Thus, for example, the term “alkylsiloxy” embraces a siloxy group substituted with one or more alkyl groups. The term “arylsiloxy” embraces a siloxy group substituted with one or more aryl groups. The term “arylalkylsiloxy” embraces a siloxy group substituted with one or more arylalkyl groups. The term “alkoxysiloxy” embraces a siloxy group substituted with one or more alkoxy groups. The term “aryloxysiloxy” embraces a siloxy group substituted with one or more aryloxy groups. The term “arylalkoxysiloxy” embraces a siloxy group substituted with one or more arylalkoxy groups.

The term “silylalkyl” embraces silyl-substituted alkyl moieties. The silylalkyl groups may be optionally substituted with one or more alkyl, aryl, arylalkyl, alkoxy, aryloxy, arylalkoxy groups, or combinations thereof. Thus, for example, the term “alkylsilylalkyl” embraces methylsilylpropyl, dimethylsilylpropyl, trimethylsilylpropyl, and the like. The term “arylsilylalkyl” embraces aryl-substituted silylalkyl groups. The term “arylalkylsilylalkyl” embraces arylalkyl substituted silylalkyl groups. The term “alkoxysilylalkyl” embraces alkoxy substituted silylalkyl groups. The term “aryloxysilylalkyl” embraces aryloxy substituted silylalkyl groups. The term “arylalkoxysilylalkyl” embraces arylalkoxy substituted silylalkyl groups.

The term “siloxyalkyl” embraces siloxy-substituted alkyl groups. The siloxyalkyl groups may be optionally substituted with one or more alkyl, aryl, arylalkyl, alkoxy, aryloxy, arylalkoxy groups, or combinations thereof. Thus, the term “alkylsiloxyalkyl” embraces alkyl substituted siloxyalkyl groups. The term “arylsiloxyalkyl” embraces aryl substituted siloxyalkyl groups. The term “arylalkylsiloxyalkyl” embraces arylalkyl substituted siloxyalkyl groups. The term “alkoxysiloxyalkyl” embraces alkoxy substituted siloxyalkyl groups. The term “aryloxysiloxyalkyl” embraces aryloxy substituted siloxyalkyl groups. The term “arylalkoxysiloxyalkyl” embraces arylalkoxy substituted siloxyalkyl groups.

The term “silylalkoxy” embraces silyl-substituted alkoxy groups. The silylalkoxy group may be optionally substituted with one or more alkyl, aryl, arylalkyl, alkoxy, aryloxy, arylalkoxy groups, or combinations thereof. Thus, for example, the term “alkylsilylalkoxy” embraces alkyl substituted silylalkoxy groups. The term “arylsilylalkoxy” embraces aryl substituted silylalkoxy groups. The term “arylalkylsilylalkoxy” embraces arylalkyl substituted silylalkoxy groups. The term “alkoxysilylalkoxy” embraces alkoxy substituted silylalkoxy groups. The term “aryloxysilylalkoxy” embraces aryloxy substituted silylalkoxy groups. The term “arylalkyloxysilylalkoxy” embraces aryl alkyloxy substituted silylalkoxy groups

The term “siloxyalkoxy” embraces siloxy-substituted alkoxy groups. The siloxyalkoxy group may be optionally substituted with one or more alkyl, aryl, arylalkyl, alkoxy, aryloxy, arylalkoxy groups, or combinations thereof. Thus, for example, the term “alkylsiloxyalkoxy” embraces alkyl substituted siloxyalkoxy groups. The term “arylsiloxyalkoxy” embraces aryl substituted siloxyalkoxy groups. The term “arylalkylsiloxyalkoxy” embraces arylalkyl substituted siloxyalkoxy groups. The term “alkoxysiloxyalkoxy” embraces alkoxy substituted siloxyalkoxy groups. The term “aryloxysiloxyalkoxy” embraces aryloxy substituted siloxyalkoxy groups. The term “arylalkoxysiloxyalkoxy” embraces arylalkyloxy substituted siloxyalkoxy groups.

The present invention relates to photopolymerizable TOSU-based compositions containing functional components. These compositions can be used as dental matrix resins. More specifically, the composition of the present invention includes an organosilicon monomer, such as a silorane, and a TOSU, which can undergo polymerization with reduced shrinkage under some conditions. The TOSU is preferably a potential expanding monomer. The specific type of TOSUs utilized in the composition of the present invention may be classified as 1,5,7,11-tetraoxaspiro[5.5]undecanes or 2,4,8,10-tetraoxaspiro[5.5]undecanes, and may have a silicon-containing moiety. By using the TOSUs, the composition has the potential of reducing the amount of polymerization stress of the total formulation.

Various TOSUs are set forth in Chappelow et al., U.S. Pat. No. 6,825,364; Chappelow et al., U.S. Pat. No. 6,653,486; Chappelow et al., U.S. Pat. No. 6,658,865; Byerley et al., U.S. Pat. No. 5,556,896; Sadhir & Luck, Expanding Monomers: Synthesis, Characterization, and Applications, CRC Press, Boca Raton, Fla. (1992), Rokicki, Aliphatic cyclic carbonates and spiroorthocarbonates as monomers, Prog. Polym. Sci. 25, 259-342 (2000), which are incorporated by reference. Further, in the present invention, novel TOSUs have been prepared. These novel TOSUs are characterized by the Formulas A1 and A2:

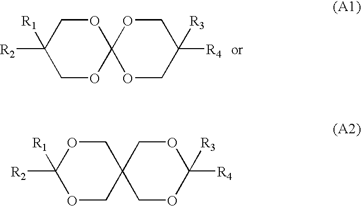

wherein R₁ and R₃ are independently is alkyl, aryl, aralkyl, or hydrogen; and

wherein R₂ and R₄ are independently alkenoxy, alkenoxyalkyl, or silicon-containing moiety selected from alkylsilyl, arylsilyl, arylalkylsilyl, alloxysilyl, aryloxysilyl, arylalkoxysilyl, alkylsiloxy, arylsiloxy, arylalkylsiloxy, alkoxysiloxy, aryloxysiloxy, arylalkoxysiloxy, alkylsilylalkyl, arylsilylalkyl, arylalkysilylalkyl, alkoxysilylalkyl, aryloxysilylalkyl, arylalkoxysilylalkyl, alkylsiloxyalkyl, arylsiloxyalkyl, arylalkylsiloxyalkyl, alkoxysiloxyalkyl, aryloxysiloxyalkyl, arylalkoxysiloxyalkyl, alkylsilylalkoxy, arylsilylalkoxy, arylalkylsilylalkoxy, alkoxysilylalkoxy, aryloxysilylalkoxy arylalkyloxysilylalkoxy, alkylsiloxyalkoxy, arylsiloxyalkoxy, arylalkylsiloxyalkoxy, alkoxysiloxyalkoxy, aryloxysiloxyalkoxy, and arylalkoxysiloxyalkoxy.

In another aspect, the novel TOSUs are characterized by Formulas A1 or A2 wherein R₂ and R₄ are independently alkylsilylalkyl or alkylsiloxyalkyl. In one preferred aspect, R₂ and R₄ are independently trimethylsilylpropyl, trimethylsilylethyl, triethylsilylpropyl, or triethylsilylethyl.

In another aspect, the present invention is directed to compounds according to Formula A1 wherein R₁ and R₃ are independently is alkyl, aryl, aralkyl, or hydrogen; and wherein R₂ and R₄ are independently alkenoxy, alkenoxyalkyl, or silicon-containing moiety selected from alkylsilyl, arylsilyl, arylalkylsilyl, alloxysilyl, aryloxysilyl, arylalkoxysilyl, alkylsiloxy, arylsiloxy, arylalkylsiloxy, alkoxysiloxy, aryloxysiloxy, arylalkoxysiloxy, alkylsilylalkyl, arylsilylalkyl, arylalkysilylalkyl, alkoxysilylalkyl, aryloxysilylalkyl, arylalkoxysilylalkyl, alkylsiloxyalkyl, arylsiloxyalkyl, arylalkylsiloxyalkyl, alkoxysiloxyalkyl, aryloxysiloxyalkyl, arylalkoxysiloxyalkyl, alkylsilylalkoxy, arylsilylalkoxy, arylalkylsilylalkoxy, alkoxysilylalkoxy, aryloxysilylalkoxy arylalkyloxysilylalkoxy, alkylsiloxyalkoxy, arylsiloxyalkoxy, arylalkylsiloxyalkoxy, alkoxysiloxyalkoxy, aryloxysiloxyalkoxy, and arylalkoxysiloxyalkoxy.

In still another aspect, the present invention is directed to compounds according to Formula A1 wherein R₁ and R₃ are independently is alkyl, aryl, aralkyl, or hydrogen; and wherein R₂ and R₄ are independently alkenoxyalkyl or alkylsilylalkyl. In still another aspect, R₂ and R₄ are independently alkenyloxyalkyl selected from —(CH₂)ₙ—O—(CH₂)ₘ—CH══CH₂, and wherein m and n are independently 0, 1, 2, 3, 4; or alkylsilylalkyl selected from trimethylsilylpropyl and trimethylsilylethyl.

In another aspect, the present invention is directed to compounds according to the Formula A2 wherein R₁ and R₃ are independently is alkyl, aryl, aralkyl, or hydrogen; and wherein R₂ and R₄ are independently alkenyl, alkenoxy, alkenoxyalkyl, or silicon-containing moiety selected from alkylsilyl, arylsilyl, arylalkylsilyl, alloxysilyl, aryloxysilyl, arylalkoxysilyl, alkylsiloxy, arylsiloxy, arylalkylsiloxy, alkoxysiloxy, aryloxysiloxy, arylalkoxysiloxy, alkylsilylalkyl, arylsilylalkyl, arylalkysilylalkyl, alkoxysilylalkyl, aryloxysilylalkyl, arylalkoxysilylalkyl, alkylsiloxyalkyl, arylsiloxyalkyl, arylalkylsiloxyalkyl, alkoxysiloxyalkyl, aryloxysiloxyalkyl, arylalkoxysiloxyalkyl, alkylsilylalkoxy, arylsilylalkoxy, arylalkylsilylalkoxy, alkoxysilylalkoxy, aryloxysilylalkoxy arylalkyloxysilylalkoxy, alkylsiloxyalkoxy, arylsiloxyalkoxy, arylalkylsiloxyalkoxy, alkoxysiloxyalkoxy, aryloxysiloxyalkoxy, and arylalkoxysiloxyalkoxy.

In another aspect, the present invention is directed to compounds according to the Formula A2 wherein R₁ and R₃ are independently is alkyl, aryl, aralkyl, or hydrogen; and wherein R₂ and R₄ are independently alkenyl, alkenoxyalkyl, and alkylsilylalkyl. In sgtill a further aspect, R₂ and R₄ are independently alkenyl selected the group consisting of —(CH₂)ₙ—CH══CH₂, and wherein n is independently 0, 1, 2, 3, 4; or alkenyloxyalkyl selected from —(CH₂)ₙ—O—(CH₂)ₘ—CH══CH₂, and wherein m and n are independently 0, 1, 2, 3, 4; or alkylsilylalkyl selected from trimethylsilylpropyl and trimethylsilylethyl.

In another aspect, the novel TOSUs are selected from the group consisting of 3,9-diethyl-3,9-bis(allyloxymethyl)-1,5,7,11-tetraoxaspiro[5.5]undecane (DEBAOM-1,5,7,11-TOSU) 1; 3,9-bis(3-trimethylsilylpropyl)-1,5,7,11-tetraoxaspiro[5.5]undecane (BTMSP-1,5,7,11-TOSU) 2; 3,9-bis(allyloxymethyl)-2,4,8,10-tetraoxaspiro[5.5]undecane (BAOM-2,4,8,10-TOSU) 3; 3,9-bis(2-trimethylsilylethyl)-2,3,8,10-tetraoxaspiro[5.5]undecane (BTMSE-2,4,8,10-TOSU) 4; and 3,9-diethyl-3,9-bis(3-trimethylsilylpropyloxymethyl)-1,5,7,11-tetraoxaspiro[5.5]-undecane (DEBTMSPOM-1,5,7,11-TOSU) 6.

Various organosilicon monomers useful in dental composites are known in the art. Examples are set forth in Weinmann et al. U.S. Pat. No. 6,908,953; Weinmann et al. U.S. Pat. No. 6,245,828 entitled “Polymerizable Compositions Based on Epoxides” and Bissinger et al., U.S. Pat. No. 6,624,236 entitled “Cyclosiloxane-Based Cross-Linkable Monomers, Production Thereof in Polymerizable Materials,” which are incorporated by reference. Most-preferred organosilicon monomers are “siloranes,” which generally refer to monomers containing both oxirane and siloxane moieties. Most preferred are multifunctional cycloaliphatic siloxane-based oxiranes. Exemplary organosilicon monomers useful for forming the dental matrix resins of the present invention include di-3,4-epoxy cyclohexylmethyl-dimethyl-silane (DiMe-Sil; RN 349660-80-6; MF, C₁₆H₂₈O₂Si; 95% purity), 1,4-bis(2,3-epoxypropyloxypropyl-dimethylsilyl)benzene (Phen-Glyc; RN 18715-54-3; MF, C₂₂H₃₈O₄Si₂; 97% purity), and 1,3,5,7-tetrakis(ethyl cyclohexane epoxy)-1,3,5,7-tetramethyl cyclotetrasiloxane (TET-Sil; RN 121225-98-7; MF, C₃₆H₆₄O₈Si₄, 98% purity), all available from 3M-ESPE (St. Paul, Minn.). Exemplary siloranes are set forth in Weinmann et al., Volume shrinkage of a new filling material based on siloranes, J. Dent. Res., 2001; 80(SI):780, Abstr. No. 2027; Weinmann et al., Comparative testing of volumetric shrinkage and sealing of silorane and methacrylate filling materials, J. Dent. Res, 2002; 81(SI-A):417, Abstr. No. 3382; Dede et al., Comparison of two ways to determine polymerization shrinkage of composites, J. Dent. Res., 2004; 83(SI-A), Abstr. No. 0057, Guggenberger et al., Exploring beyond methacrylates, Am J Dent. 2000 November; 13(Spec No):82D-84D; Schwekl, The induction of gene mutations and micronuclei by oxiranes and siloranes in mammalian cells in vitro, J. Dent. Res. 2004 January; 83(1):17-21, Eick et al., Stability of silorane dental monomers in aqueous systems, J. Dent. 34(6):405-10 (2006), Watts, Shrinkage-Stress Kinetics of Silorane versus Dimethacrylate Resin-Composites, 12 Mar. 2005 Baltimore Convention Center 322-323 (Abstract), and Klettke et al., U.S. Pat. No. 6,779,656, which are incorporated by reference. A preferred silorane is the two-component silorane-based resin (“SIL-MIX”), composed of a 1:1 w/w (2:1 mol/mol) ratio of methylbis[2-(7-oxabicyclo[4.1.0]hept-3-yl)ethyl]phenylsilane I (PH-SIL) and 2,4,6,8-tetramethyl-2,4,6,8-tetrakis-[2-(7-oxabicyclo[4.1.0]hept-3-yl)ethyl]-1,3,5,7-tetraoxa-2,4,6,8-tetrasilacyclooxtane II, (TET-SIL) produced by 3M-ESPE (St. Paul, Minn.). The structures SIL-MIX compounds are shown below:

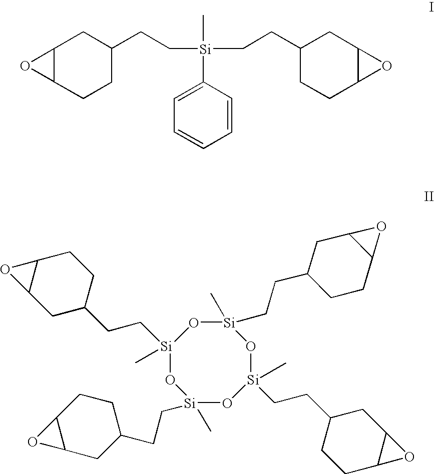

Still further, the formulation of the present invention may include a photoinitiator (“PI”), photosensitizer (PS), and/or reaction promoter (“RP”). A typical photoinitiator is a diaryliodonium salt. Examples of other photoinitiators (PIs) that may be used in the composition of the present invention include, but are not limited to, (4-n-octyloxyphenyl)phenyliodonium hexafluoroantimonate (“OPIA”), which may be obtained from GE Silicones under number 479-2092C; [4-(2-hydroxytetradecyloxyphenyl)]phenyliodonium hexafluoroantimonate (CD 1012), which may be obtained from Sartomer under the tradename SarCat CD-1012 or from Gelest under the tradename OMAN072; [4-1-methylethyl)phenyl](4-methylphenyl)iodonium tetrakis(pentafluorophenyl)borate(1-) (RH02074), which may be obtained from Rhodia, Inc., under the tradename Rhodorsil Photoinitiator 2074; and combinations thereof

A typical photosensitizer is an alpha-dicarbonyl compound. Examples of specific photosensitizers (PSs) that may be used in the composition of the present invention include, but are not limited to, (+/−) camphorquinone (CQ), which may be obtained from Aldrich under the number 12,489-2 with a 97% purity; 2-chlorothioxanthen-9-one (CTXO), which may be obtained from Aldrich C7-240-4; and combinations thereof.

Examples of reaction promoters (“RPs”) that may be used in the composition of the present invention include, but are not limited to, ethyl p-dimethylaminobenzoate (“EDMAB”), which may be obtained from Acros under number 11840-1000 at 99+% purity; 4,4′-bis(diethylamino)benzophenone (“BDEAB”), which also may be obtained from Acros under number 17081-0250s at 99+% purity; and combinations thereof.

The composition of the present invention is made by combining the above-described components together. The composition may then be cationically polymerized to form a dental matrix resin.

Examples 1-6 are directed to methods of making the novel TOSUs of the present invention. Examples 7-11 illustrate photopolymerizable mixtures of the present invention that have been formulated, polymerized, and characterized. These examples are not meant to limit the scope of this invention in any way.

Materials

In the following examples, a conventional methacrylate-based dental matrix resin formulation (“BT”) containing 2,2-bis[4-(2-hydroxy-3-methacryloyloxypropoxy)phenyl]propane (“BIS-GMA”) and triethylene glycol dimethacrylate (“TEGDMA”), were supplied by 3M-ESPE, St. Paul, Minn. and Seefeld, Germany. The photoinitiator system components included phenyl[p-(2-hydroxytetradecyloxy)phenyl]iodoniumhexafluoroantimonate (“PI”) (OMAN072, Gelest); camphorquinone, CQ (Aldrich); and ethyl 4-dimethylaminobenzoate (“ED”) (Fisher/ACROS). The synthesis reagents included trimethylolpropane allyl ether (Aldrich), allyl alcohol, bromoacetaldehyde, 2,2-diethyl-1,3-propanediol, thiophosgene, 3-cyclohexene-1,1-dimethanol, dibutyltin oxide, m-chloroperbenzoic acid (mCPBA), lithium aluminum hydride (“LAH”) and sodium metal (Aldrich); 4-(dimethylamino)pyridine DMAP (“ACROS”); pentaerythritol (Avocado); acrolein (AlfaAesar); anhydrous p-toluene sulfonic acid (“pTSA”) was prepared by drying the monohydrate (Aldrich) at 100° C. in vacuo for about 6 hours using the procedures of Endo, Macromol 1987, 20, 1416.; tetraethylorthocarbonate C(OEt)₄, or TEOC was synthesized according to a reported procedure in Roberts & McMahon, Org. Syn. 1952, 32, 68; Wilkinson's catalyst, tris(triphenylphosphine)rhodium chloride RhCl(Ph₃P)₃ (Strem); trimethylsilane (CH₃)₃SiH (Gelest); hexanes, anhydrous ether Et₂O, toluene, methylene chloride CH₂Cl₂, triethylamine Et₃N, acetic acid, sodium bicarbonate NaHCO₃, anhydrous magnesium sulfate MgSO₄, anhydrous sodium sulfate Na₂SO₄, potassium sodium tartrate tetrahydrate (Rochelle's salt), sodium hydroxide NaOH, hydroquinone HQ, and silica gel (Fisher).

Statistical Methods

For photopolymerization stress and mechanical properties results discussed in the examples below, an analysis of variance (ANOVA, one way) was carried out to assess the impact of formulations on dependent measures. Results for silorane-based test formulations were analyzed for significant differences as compared to a standard methacrylate control using Dunnett's post hoc t-test (2-sided; p=0.05).

### EXAMPLE 1

### Synthesis of 3,9-Diethyl-3,9-bis(allyloxymethyl)-1,5,7,11-tetraoxaspirol[5.5]undecane (DEBAOM-1,5,7,11-TOSU)

The synthesis scheme for 3,9-diethyl-3,9-bis(allyloxymethyl)-1,5,7,11-tetraoxaspiro[5.5]undecane (DEBAOM-1,5,7,11-TOSU) is shown in the scheme below. The transesterification procedure was similar to that of Endo et al., Synthesis and cationic polymerization of 3,9-dibenzyl-1,5,7,11-tetraoxaspiro[5.5]undecane, Macromol. 1987, 20, 1416. To a three-neck 1 L round-bottom flask equipped with magnetic stir bar, Dean-Stark trap with reflux condenser, and a thermometer, was placed a mixture of toluene (500 mL) and the starting trimethylolpropane allyl ether (1a; 8.89 g, 50 mmol). The solution was refluxed for about 2 hours to azetropically remove water. About 25 mL of azeotrope was collected. The mixture was allowed to cool to below about 70° C. Anhydrous p-tolulene sulphonic acid (“pTSA”) (0.09 g) was added and the mixture was allowed to cool to room temperature. Tetraethylorthocarbonate C(OEt)₄ (1b; 5.39 mL, 25 mmol) was added slowly. The resulting mixture was refluxed to azeotropically remove the by-product ethanol C₂H₅OH. The azeotropic mixture (160 mL) was shaken with brine to determine the amount of ethanol collected. The reaction mixture was allowed to reflux for an additional hour and then allowed to cool to room temperature. Triethylamine Et₃N (2 mL) was added and the resulting mixture was stirred at room temperature for 1.5 hour and concentrated under reduced pressure to obtain a light yellow liquid (14.84 g). This crude material was purified by flash chromatography (silica gel, 10-20% anhydrous ether Et₂O/hexanes) and the desired product 1 (DEBAOM-1,5,7,11-TOSU) was obtained as colorless liquid in 98% yield (8.92 g). Purity (GC): ˜96%; DSC exotherm peak: 184.48° C.; ¹H-NMR (CDCl₃, 400 MHz) δ 5.93-5.81 (m, 2H), 5.29-5.21 (dd, 2H, J=12.9, 1.2 Hz), 5.17-5.12 (dd, 2H, J=7.8, 0.9 Hz), 3.99-3.95 (d, 4H, J=3.9 Hz), 3.85-3.66 (m, 12H), 3.47 (s, 4H), 1.42-1.35 (q, 4H, J=5.7 Hz), 0.85-0.79 (t, 6H, J=5.7 Hz); ¹³C-NMR (CDCl₃, 400 MHz) δ 134.74, 116.36, 114.75, 72.13, 69.25, 67.39, 66.97, 36.16, 23.42, 7.11; FTIR (cm⁻¹) 3081, 2966, 2882, 1646, 1456, 1364, 1261, 1228, 1189, 1112, 1071, 1014, 927.

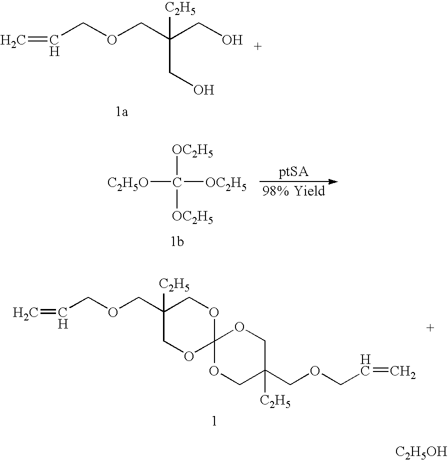

### EXAMPLE 2

### Synthesis of 3,9-Bis(3-trimethylsilylpropyl)-1,5,7,11-tetraoxaspiro[5.5]undecane (BTMSP-1,5,7,11-TOSU)

The three-step synthesis scheme of 3,9-bis(3-trimethylsilylpropyl)-1,5,7,11-tetraoxaspiro[5.5]undecane (BTMSP-1,5,7,11-TOSU) is shown below. The first step involved preparation of 2-allyl-propane-1,3-diol 2a. To a 4-neck, 1 L round-bottom flask under argon, with dropping furmel, reflux condenser, thermometer, and sparkiess mechanical stirrer was charged about 560 mL anhydrous ether Et₂O. The system was stirred and cooled to about 5° C. and lithium aluminum hydride (“LAH”) (18.40 g, 0.4606 mole) was added to the flask followed by diethyl allylmalonate (2b; 42.19 g, 0.2044 mole) in 15 mL anhydrous ether Et₂O over a period of about 0.5 hours. Upon completion of addition the reaction mixture refluxed (34-35° C.) for about 6 hours, allowed to cool to room temperature, and stirred slowly overnight. The reaction mixture was then cooled to about 5° C. and quenched with MeOH (51 mL) and slowly poured into 700 mL of cold saturated Rochelle's salt solution. The heterogeneous mixture was stirred until whitish and then was extracted with about 600 mL anhydrous ether Et₂O. Both the aqueous and organic phase were neutralized to a pH of about 7 by slowing adding small pieces of dry ice under vigorous stirring. The aqueous phase was back extracted with anhydrous ether Et₂O two more times (2×600 mL). All the organic phases were combined, dried over Na₂SO₄, filtered, and stripped of volatiles yielding 35.1 g of crude product which was purified by distillation at 0.14-0.16 mm Hg through a 8″ Vigreaux column to give 20.2 g (85% yield) of colorless diol 2a. Bp: 70-72° C./0.14-0.16 mm Hg; Purity (GC): 97%; ¹H-NMR (CDCl₃, 400: MHz) δ 5-82-5.72 (m, 1H), 5.07-5.00 (m, 2H), 3.78-3.74 (d, d, 2H, J=4 Hz), 3.64-3.60 (d, d, 2H, J=7.2 Hz), 3.16 (s, 2H), 2.05-2.01 (m, 2H), 1.86-1.80 (m, 1H); ¹³C-NMR (CDCl₃, 400 MHz) δ136.15, 116.53, 65.34, 41.72, 32.45; FTIR (cm⁻¹) 3338, 3077, 2927, 2980, 1641, 1470, 1442, 1092, 1035, 995, 970, 915.

In the second step, 3,9-bis(allyl)-1,5,7,11-tetraoxaspiro[5.5]undecane 2c, was prepared as follows. Into a flame-dried 3-neck 250 mL round-bottom flask under argon, with Dean Stark trap, reflux condenser, stir bar, and a thermometer were charged the diol 2a from the first step above (35.52 g, 0.28 mole), C(OEt)₄ (27.75 g, 0.140 mole), and dry pTSA (0.50 g). The heterogeneous mixture was stirred and was slowly heated to 111° C. over a period of 2 h to azeotropically remove the ethanol byproduct (24 mL; 92% of theory). The reaction mixture was then neutralized (1.5 mL Et₃N) to pH of about 9, and stripped under reduced pressure to giving 33.68 g of crude product as a yellowish oil which was subjected to vacuum distillation at 0.23 mm Hg to give 22.96 g (85% yield) of the colorless product 2c which solidified easily at room temperature. Bp: 111-112° C./0.23 mm Hg; Mp (DSC): 42.13° C.; Purity (GC) 99%; ¹H-NMR (CDCl₃, 400 MHz) δ 5.74-5.64 (m, 2H), 5.06-5.00 (m, 4H), 4.01-3.91 (m, 4H), 3.79-3.74 (m, 2H), 3.68-3.63 (m, 2H), 2.03-1.94 (m, 6H); ¹³C-NMR (CDCl₃, 400 MHz) δ 134.82, 117.05, 114.36, 66.51, 66.07, 32.61, 32.36; FTIR (cm⁻¹) 3084, 2995, 2976, 2893, 1640, 1457, 1378, 1354, 1238, 1202, 1158, 1099, 1022, 998, 984, 935.

The third step involved production of 3,9-Bis(3-trimethylsilylpropyl)-1,5,7,11-tetraoxaspiro[5.5]undecane (BTMSP-1,5,7,11-TOSU) 2. The general hydrosilylation procedure was similar to that reported by Crivello et al., Regioselective Hydrosilations. I. The Hydrosilation of α,ω-Dihydrogen Functional Oligopolydimethylsiloxanes with 3-Vinyl-7-oxabicyclo[4.1.0]heptane, J. Polym. Sci. A Polym. Chem. 1993, 31, 2563. To a flame-dried three-neck 250 mL round-bottom flask with magnetic stir bar, thermometer, dry ice-acetone cold finger, and addition port were placed the diallyl spirocyclic product from above (2c; 6.07 g, 25 mmol), toluene (100 mL), and Wilkinson's catalyst [tris(triphenylphosphine)rhodium chloride RhCl(Ph₃P)₃, 2.5 mg]. Trimethylsilane gas (CH₃)₃SiH (2d; 5.62 g, 75 mmol] was bubbled very slowly through the mixture at room temperature with stirring over a period of about 3 hours. The resulting mixture was slowly heated to about 80° C., held for about 4.5 hours, cooled to room temperature, and stirred overnight. The mixture was filtered and concentrated under reduced pressure to obtain a yellowish liquid (11.96 g). The crude material was purified by column chromatography (silica gel, 10% Et₂O/hexanes). The desired hydrosilylation product 2 (BTMSP-1,5,7,11-TOSU), a white crystalline solid (4.31 g), was obtained in 44.3% yield. Mp (DSC): 69.41° C.; ¹H-NMR (CDCl₃, 400 MHz) δ 3.98-3.84 (m, 4H), 3.79-3.72 (dd, 2H, J=8.1, 7.2 Hz), 3.65-3.52 (dd, 2H, J=8.1, 7.2 Hz), 2.01-1.89 (m, 2H), 1.31-1.15 (m, 8H), 0.49-0.40 (m, 4H), −0.06 (s, 18H); ¹³C-NMR (CDCl₃, 400 MHz) δ 114.44, 67.12, 66.54, 32.57, 31.84, 21.05, 16.74, −1.73; FTIR (cm⁻¹) 2953, 2923, 1460, 1374, 1248, 1210, 1169, 1117, 1015, 860, 838. In addition, some mono-hydrosilylated by-product 3-allyl-9-(3-trimethylsilylpropyl)-1,5,7,11-tetraoxaspiro[5.5]undecane (2e; 2.0 g, 25% yield) was obtained as a colorless liquid. ¹H-NMR (CDCl₃, 400 MHz) δ 5.50-5.47 (m, 1H), 5.11-4.93 (m, 1H), 3.87-3.52 (m, 8H), 1.86 (s, 1H), 1.54 (s, 2H), 1.15 (s, 5H), 0.37 (s, 2H), 0.11-0.14 (m, 9H); ¹³C-NMR (CDCl₃, 400 MHz) δ128.58, 125.81124.38, 114.13, 113.82, 66.80, 66.71, 66.21, 66.16, 65.73, 65.23, 36.46, 32.27, 31.54, 29.90, 20.76, 19.50, 17.82, 16.42, 13.81, 12.87, −2.01; FTIR (cm⁻¹) 2954, 2922, 2884, 1456, 1373, 1246, 1210, 1114, 1006, 860, 838.

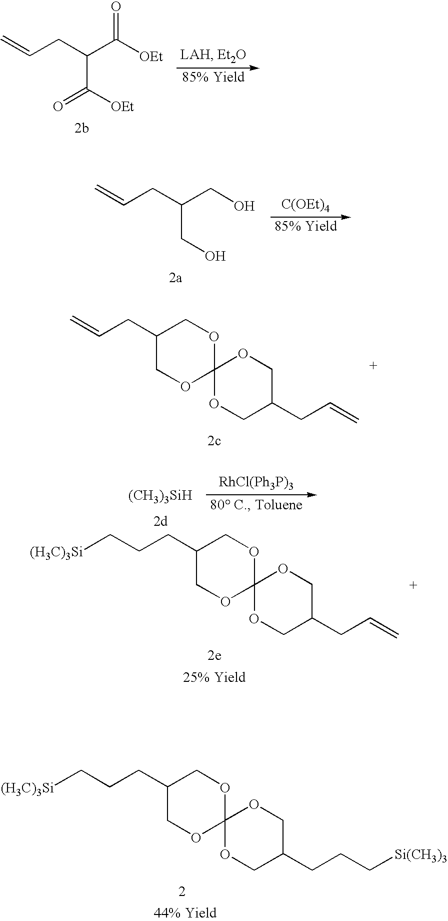

### EXAMPLE 3

### Synthesis of 3,9-Bis(allyloxymethyl)-2,4,8,10-tetraoxaspiro[5.5]undecane (BAOM-2,4,8,10-TOSU)

The two-step synthesis of 3,9-bis(allyloxymethyl)-2,4,8,10-tetraoxaspiro[5.5]undecane (BAOM-2,4,8,10-TOSU) 3 is shown in the scheme below. The first step involves production of 2-allyloxyacetaldehyde dimethyl acetal 3a. In a flame-dried 3-neck 1 L round bottom flask under argon, with dropping funnel, reflux condenser, thermometer, and a stir bar, was placed allyl alcohol (345 mL, 5.02 mol). Sodium (1.14 mol) was added slowly in small pieces with vigorous stirring and gradual heating to about 90° C. HQ (0.2 g) was then added. The sodium alcoholate 3b was heated to about 93-100° C. while bromoacetaldehyde (3c; 193.32 g, 1.14 mol) was added at the rate of about 1.5 to 2 mL/min. Half way through the addition white precipitates were formed. The reaction mixture was allowed to cool to room temperature, stirred overnight, reheated to about 99-100° C. for 8 hours, again allowed to cool to room temperature, and was filtered under aspiration and argon. Into the filtrate (pH 9-10), about 5 mL acetic acid was added over a period of about 45 minutes. The neutralized filtrate was concentrated to about 70 mL (120 mm Hg, ˜53° C. to about 60 mm Hg, 50-67° C.) and allowed to stand overnight. This residue was filtered under argon and the filtrate was stripped under reduced pressure to obtain 66.04 g crude product which was then distilled using an 11-plate Oldershaw at 25 mm Hg, 73° C. (reflux ratio 1.0-1.2) to obtain 51.95 g (yield 31%) of the dimethyl acetal 3a as a colorless liquid. Purity (GC): 99%; ¹H-NMR (CDCl₃, 400 MHz) δ 5.93-5.83 (m, 1H), 5.28-5.22 (qq, J=10.8 Hz, 1H), 5.18-5.15 (dd, J=5.8 Hz, 1H), 4.51-4.48 (t, J=5.2 Hz, 1H), 4.02-4.00 (J=4.0 Hz, 2H), 3.47, 3.45 (s, s, 2H), 3.37 (s, 6H); ¹³C-NMR (CDCl₃, 400 MHz,) δ 134.43, 117.45, 102.76, 72.45, 69.62, 53.89; FTIR (cm⁻¹) 3082, 2988, 2912, 2833, 1648, 1448, 1194, 1114, 1080, 1067, 993, 926.

In the second step, 3,9-bisallyloxymethyl-2,4,8,10-tetraoxaspiro[5.5]undecane [BAOM-2,4,8,10-TOSU] 3 is produced. To a 3-neck 100 mL round bottom flask with Dean Stark trap, reflux condenser, thermometer and stir bar were charged 2-allyloxyacetaldehyde the dimethyl acetal from above (3a; 29.50 g, 201.80 mmol), pentaerythritol (3d; 14.00 g, 100.9 mmol) and pTSA (0.45 g). The heterogeneous mixture was heated to 110-150° C. for about 7 hours and about 3.4 mL MeOH were collected. Upon cooling to room temperature, Et₃N (5 mL) was added, the mixture was stirred for about 0.5 hours at about 45° C. (pH 8-9). The crude product was purified by flash chromatography with a deactivated (2% Et₃N) column (silica gel, hexanes/Et₂O 1/1, V/V) to obtain the desired product BAOM-2,4,8,10-TOSU (3; 13.55 g, 45% yield) as a colorless liquid. Purity (GC): ˜95%; ¹H-NMR (CDCl₃, 400 MHz) δ 5.91-5.81 (m, 2H), 5.26-5.14 (qqqq, J=24.2 Hz, 4H), 4.63-4.60 (m, 2H), 4.56-4.53 (m, 2H), 4.01-3.96 (m, 4H), 3.61-3.52 (m, 4H), 3.49-3.36 (m, 4H), 3.38-3.08 (m, 2H); ¹³C-NMR (CDCl₃, 400 MHz,) δ 134.14, 117.70, 100.59, 72.62, 70.93, 70.35, 69.87, 32.74; FTIR (cm⁻¹) 3080, 2981, 2910, 2855, 1647, 1464, 1204, 1170, 1119, 1067, 927, 858.

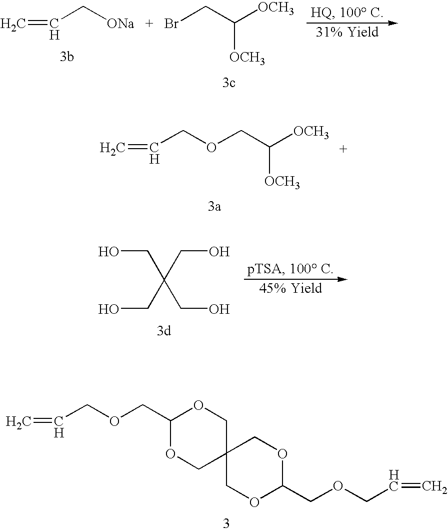

### EXAMPLE 4

### Synthesis of 3,9-Bis(2-trimethylsilylethyl)-2,4,8,10-tetraoxaspiro[5.5]undecane (BTMSE-2,4,8,10-TOSU)

The two-step synthesis scheme for 3,9-Bis(2-trimethylsilylethyl)-2,4,8,10-tetraoxaspiro[5.5]undecane (BTMSE-2,4,8,10-TOSU) is shown in the scheme below. In the first step, 3,9-divinyl-2,4,8,10-tetraoxaspiro[5.5]undecane 4a is prepared. To a flame-dried three-neck 1 L round bottom flask, with stir bar, thermometer, reflux condenser, and addition funnel was charged pentaerythritol (4b; 65.30 g, 0.47 mol). Acrolein (4c; 82.65 g, 1.43 mole) was added via a dropping funnel with stirring followed by addition of 0.5 g of dry pTSA. The mixture was slowly heated to about 55° C., stirred for 4 hours, and allowed to cool to room temperature. After standing overnight, 100 mL 5% NaHCO₃ was added and the mixture stirred for 0.5 hours. After extracting with 300 mL Et₂O, the organic phase was separated and washed with 100 mL portions of 5% NaHCO₃ and brine successively (pH 7), dried over Na₂SO₄/MgSO₄, and stripped under reduced pressure to obtain 93.54 g of crude product. The crude product was distilled and the distillate was recrystallized from hexanes/ether 1/3 v/v to obtain 38.31 g (yield 38%) of the white crystalline product 4a. Bp: 90-92° C./0.5-0.65 mmHg; Purity (GC): ˜97%; Mp (DSC): 42.06° C.; ¹H-NMR (CDCl₃, 400 MHz) δ 5.87-5.79 (m, 1H), 5.47-5.42 (tt, J=1.2, 1.2 Hz, 1H), 5.31-5.28 (m, 1H), 4.86-4.85 (d, J=2.2Hz, 1H), 4.62-4.57 (m, 1H), 3.65-3.39 (m, 3H); ³¹C-NMR (CDCl₃, 400 MHz) δ 134.19, 119.00, 101.27, 70.53, 70.07, 32.33; FTIR (cm⁻¹) 2986, 2955, 2851, 1437, 1422, 1204, 1166, 1078, 978, 940.

In the second step, the desired 3,9-bis(2-trimethylsilylethyl)-2,4,8,10-tetraoxaspiro[5.5]undecane [BTMSE-2,4,8,10-TOSU] 4 is generated. The general hydrosilylation procedure was similar to that reported by Crivello. To a flame-dried three-neck 250 mL round-bottom flask with a magnetic stir bar, thermometer, dry ice-acetone cold finger, and addition port were placed the divinyl spirocyclic intermediate from above (4a; 7.14 g, 32.98 mmol), toluene (120 mL), and Wilkinson's catalyst [RhCl(Ph₃P)₃, 3.3 mg]. (CH₃)₃SiH (4d; 7.42 g, 98.94 mmol) was bubbled very slowly through the mixture at room temperature with stirring over a period of about 4 hours. The resulting mixture was slowly heated to about 80° C., held about 4.5 hours, and cooled to room temperature. The mixture was filtered and concentrated under reduced pressure to give a yellowish liquid (13.73 g). This crude product was purified by column chromatography (silica gel, deactivated with 1% Et₃N; 3-5% Et₂O/hexanes). The desired hydrosilylation product BTMSE-2,4,8,10-TOSU (4), a white crystalline solid (4.82 g), was obtained in 40.5% yield. Purity (GC): 93%; Mp (capillary): 63-66° C.; ¹H-NMR (CDCl₃, 400 MHz) δ 4.55-4.50 (dd, 2H, J=8.7, 1.8 Hz), 4.36-4.32 (t, 2H, J=3.9 Hz), 3.57-3.52 (dd, 2H, J=8.7, 1.8 Hz), 3.52-3.48 (d, 2H, J=8.7 Hz), 3.34-3.30 (d, 2H, J=8.7 Hz), 1.60-1.52 (m, 4H), 0.56-0.50 (m, 4H), −0.05 (s, 18H); ¹³C-NMR (CDCl₃, 400 MHz) δ 104.42, 70.61, 70.19, 32.41, 29.18, 10.12, −1.88; FTIR (cm⁻¹) 2953, 2853, 1457, 1380, 1250, 1208, 1170, 1122, 1050, 859, 837, 774.

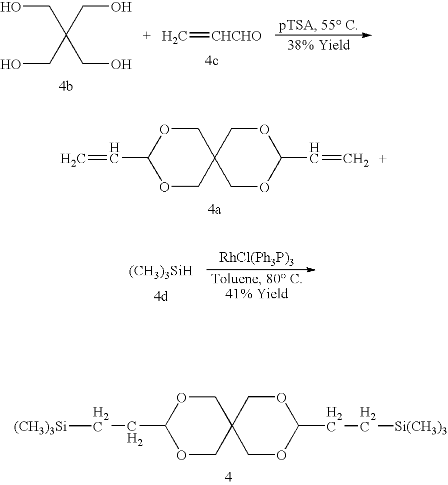

### EXAMPLE 5

### Synthesis of 3,3-Diethyl-11,12-epoxy-1,5,7,16-tetraoxadispiro[5.2.5.2]hexadecane (DECHE-1,5,7,11-TOSU)

Synthesis of 5,5-diethyl-19-oxadispiro[1,3-dioxane-2,2′-1,3-dioxane-5′,4″-bicyclo[4.1.0]heptane] (DECHE-1,5,7,11-TOSU) 5 was previously described in U.S. Pat. No. 6,653,486, which is incorporated by reference.

In this example, the four-step reaction sequence for making 3,3-diethyl-11,12-epoxy-1,5,7,16-tetraoxadispiro[5.2.5.2]hexadecane (DECHE-1,5,7,11-TOSU) 5 is shown in the scheme below. The compound is also known as 5,5-diethyl-19-oxadispiro[1,3-dioxane-2,2′-1,3-dioxane-5′,4″-bicyclo-[4.1.0]heptane (“DEODSH”). The first step involves producing 5,5-diethyl-1,3-dioxane-2-thione 5a. This thiocarbonate was prepared by a variation of the thiocarbonylation procedure developed by Correy and Hopkins, Tet Let. 1982, 23(19), 1979. To a three-neck round-bottom flask under nitrogen, with mechanical stirrer and an additional funnel, was placed 2,2-diethyl-1,3-propanediol (5b; 15.86 g, 120 mmol), DMAP (29.32 g, 240 mmol) and 120 mL toluene. The mixture was allowed to stir at room temperature until a homogeneous solution was obtained. The mixture was cooled to about 0 to 5° C. and a solution of thiophosgene (5c; 9.43 mL, 120 mmol) in about 90 mL toluene was added drop wise over a period of about 90 minutes. This resulted in the formation of a bright orange DMAP-thiophosgene complex. The reaction mixture was allowed to stir for about 1 hour at about 0 to 5° C., slowly warmed to room temperature, stirred for an additional hour before the precipitated DMAP-HCl salt was removed by filtration. The filtrate was concentrated under reduced pressure and the crude material was purified by recrystallization (dissolved in refluxing ether, allowed to cool to room temperature and ether slowly evaporated) or by column chromatography (silica gel, 2/1 v/v CH₂Cl₂/hexanes). The desired thiocarbonate 5a was obtained as white crystalline solid in 70% yield. Mp (DSC): 64.4° C.; ¹H-NMR (CDCl₃, 300 MHz) δ 4.17 (s, 4H), 1.51-1.43 (q, 4H, J=7.5 Hz), 0.92-0.87 (t, 6H, J=7.5 Hz); ¹³C-NMR (CDCl₃, 300 MHz) δ 189.53, 76.08, 33.67, 23.09, 6.97; FTIR (cm⁻¹) 2960, 2920, 1455, 1395, 1380, 1290, 1240, 1200, 1180, 1060, 990, 930, 720.

In the second step, 3,3-dibutyl-2,4-dioxa-3-stannaspiro[5.5]undec-8-ene 5d was produced. This tin adduct and the unsaturated intermediate (5g; below) were prepared employing procedures similar to those reported by Stansbury et al., Evaluation of spiro orthocarbonate monomers capable of polymerization with expansion as ingredients in dental composite-materials. Polym. Mater. Sci. Eng. 59:402-406 (1988). To a three-neck round-bottomed flask with thermometer, reflux condenser, and a Dean-Stark trap with extension condenser, was placed a heterogeneous mixture of 3-cyclohexene-1,1-dimethanol (5e; 8.48 g, 59.6 mmol, purified by recrystallization from Et₂O) and dibutyltin oxide (5f; 15.14 g, 59.6 mmol) in 250 mL of toluene. The reaction mixture was refluxed for 3 h and the liberated wateritoluene azeotrope was collected (5×20 mL). The Dean-Stark trap was removed and the reaction mixture was then refluxed for additional 2 hours and slowly cooled to room temperature under nitrogen. The dibutyltin adduct product 5d generated in situ was carried on to the subsequent reaction without further purification.

In the third step, 3,3-diethyl-1,5,7,16-tetraoxadispiro[5.2.5.2]hexadec-11-ene 5g was produced. To the solution of 5d from the second step above was added the thione product from the first step above (5a; 10.39 g, 59.6 mmol) in several small portions at room temperature over a period of about 20 minutes and stirred for about 24 hours. The reaction mixture was then concentrated under reduced pressure and the residue taken up in Et₂O (white suspension formed upon standing). The ether solution was filtered and concentrated under reduced pressure to give light yellowish oil. The crude product was purified by column chromatography (silica gel, 10-15% Et₂O/hexanes). The desired unsaturated spirocyclic product 5g was obtained as colorless oil in 94% yield. ¹H-NMR (CDCl₃, 300 MHz) δ 5.68-5.58 (m, 2H), 3.74-3.68 (4s, 8H), 2.08-1.94 (m, 4H), 1.63-1.56 (t, 2H, J=6.6 Hz), 1.46-1.37 (q, 4H, J=7.5 Hz), 0.84-0.76 (t, 6H, J=7.5 Hz); ¹³C-NMR (CDCl₃, 300 MHz) δ 126.03, 124.16, 114.68, 70.03, 69.32, 34.27, 30.50, 26.44, 23.14, 21.30, 13.92, 7.01; FTIR (cm⁻¹) 3020, 2960, 2880, 1640, 1450, 1360, 1250, 1220, 1200, 1185, 1160, 1105, 1020, 995, 920, 730, 655; Anal. Calculated for C₁₆H₂₆O₄: C, 68.06; H, 9.28. Found: C, 68.20; H, 9.59.

In the final step, the desired product 3,3-diethyl-11,12-epoxy-1,5,7,16-tetraoxadispiro[5.2.5.2]hexadecane (DECHE-1,5,7,11-TOSU) 5 is produced. This tetraoxabispirocyclic oxirane was prepared employing the biphasic epoxidation procedure described by Anderson and Veysoglu, J. Org. Chem. 1973, 38, 2267 due to the acid sensitive nature of this class of compounds. In a round-bottomed flask was placed the unsaturated intermediate 5g from the third step above (10.02 g, 35.4 mmol) and 350 mL CH₂Cl₂. To this was added 0.5 M aqueous NaHCO₃ (110 mL, pH˜8). The resulting biphasic mixture was allowed to stir vigorously at room temperature and then mCPBA (9.00 g, ˜35.77 mmol) was slowly added in several portions over a period of 30 minutes. The resulting mixture was stirred for 5 hours at room temperature. The two phases were separated and the organic phase was washed successively with 1 N aqueous NaOH (2×100 mL) and water (2×100 mL), dried over anhydrous Na₂SO₄, and concentrated under reduced pressure to give an off-white solid. The crude product was washed with 5 mL of cold Et₂O) (pre-cooled at 0° C.) and purified by flash chromatography (silica gel, 15% ethyl ether/hexanes) or by two recrystallizations from Et₂O/hexanes (the crude material was dissolved in refluxing ether, allowed to cool to room temperature and then hexanes was slowly added). The desired oxiranyl spirocyclic product DECHE-1,5,7,11-TOSU 5 was obtained as a white crystalline solid in 90% yield. Mp (DSC): 67.4° C.; ¹H-NMR (CDCl₃, 300 MHz, mixture of diastereomers) δ 3.70-3.50 (m, 8H), 3.16-3.04 (m, 2H), 2.08-1.92 (m, 2H), 1.80-1.60 (m, 2H), 1.44-1.18 (m, 6H), 0.86-0.70 (m, 6H); ¹³C-NMR (CDCl₃, 300 MHz, mixture of diastereomers) δ 114.53, 71.56, 69.45, 69.33, 68.98, 51.57, 50.07, 34.30, 31.43, 29.41, 29.29, 23.21, 23.09, 22.79, 19.86, 13.95, 7.07, 7.00; FTIR (KBr pellet) (cm⁻¹) 2970, 1455, 1365, 1255, 1225, 1205, 1180, 1110, 1060, 1020, 1000, 920, 810, 795, 780, 730; Anal. Calculated for C₁₆H₂₆O₅: C, 64.41; H, 8.78. Found: C, 64.86; H, 8.93.

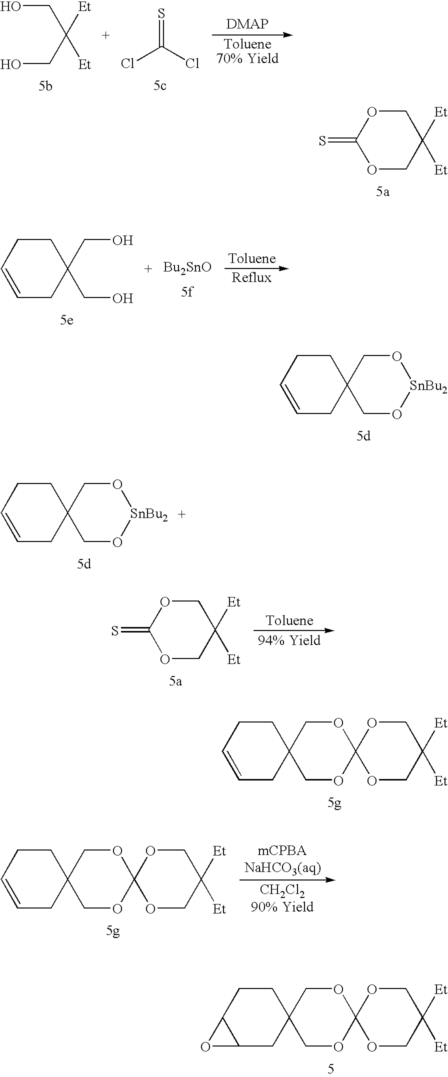

### EXAMPLE 6

### Synthesis of 3,9-Diethyl-3,9-bis(3-trimethylsilylpropyloxymethyl)-1,5,7,11-tetraoxaspiro[5.5]undecane (DEBTMSPOM-1,5,7,11-TOSU)

In this example, 3,9-diethyl-3,9-bis(3-trimethylsilylpropyloxymethyl)-1,5,7,11-tetraoxaspiro[5.5]undecane DEBTMSPOM-1,5,7,11-TOSU (6) was prepared as follows. To a flame-dried three-neck 250 mL round-bottom flask equipped with a magnetic stir bar, a thermometer, a reflux condenser fitted with a dry ice-acetone cold finger, and an addition port were placed the diallyl ether intermediate (8.91 g, 25 mmol), toluene (80 mL), and Wilkinson's catalyst, tris(triphenylphosphine)rhodium chloride, (2.5 mg). To the mixture at room temperature was bubbled very slowly trimethylsilane gas (4.95 g, 66.7 mmol) via the addition port with stirring over a period of 3 hours. The resulting mixture was slowly heated to 80° C. and held at this temperature for 3.5 hours. The reaction was monitored by TLC (silica gel, 50% ether/hexanes). The mixture was then allowed to stir at room temperature overnight, filtered, and concentrated under reduced pressure to give a turbid yellowish liquid (13.85 g). The crude material was purified by column chromatography (silica gel, 5-10% ethyl ether/hexanes). The desired hydrosilylation product 6 was obtained in 73.6% yield (9.29 g) as a colorless liquid that solidified upon sitting overnight. Purity ˜96% by GC; Mp (DSC) 44.27° C.; ¹H-NMR (CDCl₃, 400 MHz) δ 3.78-3.59 (m, 8H), 3.38 (s, 4H), 3.34-3.28 (t, 4H, J=5.1 Hz), 1.52-1.43 (m, 4H), 1.36-1.28 (q, 4H, J=5.7 Hz), 0.8-0.72 (t, 6H, J=5.7 Hz), 0.43-0.37 (m, 4H), −0.08 (s, 18H); ¹³C-NMR (CDCl₃, 400 MHz) δ 114.78, 74.30, 69.66, 67.45, 67.03, 36.19, 23.84, 23.49, 12.41, 7.16, −1.86; FTIR (cm^{31 1}) 2955, 2875, 1461, 1366, 1250, 1225, 1188, 1114, 1070, 1010, 860, 754, 693; Anal. Calcd. for C₂₅H₅₂O₆Si₂: C, 59.48; H, 10.38. Found: C, 60.07; H, 10.89.

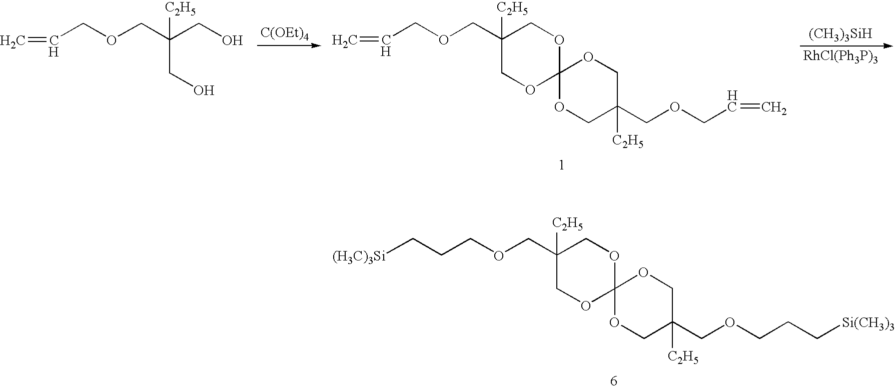

### EXAMPLE 7

### Photoreactivity Assessment

In this example, the photoreactivity of various combinations of SIL-MIX alone or SIL-MIX with 3,9-diethyl-3,9-bis(allyloxymethyl)-1,5,7,11-tetraoxaspiro[5.5]undecane (DEBAOM-1,5,7,11-TOSU) 1; 3,9-bis(3-trimethylsilylpropyl)-1,5,7,11-tetraoxaspiro[5.5]undecane (BTMSP-1,5,7,11-TOSU) 2; 3,9-bis(allyloxymethyl)-2,4,8,10-tetraoxaspiro[5.5]undecane (BAOM-2,4,8,10-TOSU) 3; 3,9-bis(2-trimethylsilylethyl)-2,3,8,10-tetraoxaspiro[5.5]undecane (BTMSE-2,4,8,10-TOSU) 4; 3,3-diethyl-11,12-epoxy-1,5,7,16-tetraoxadispiro[5.2.5.2]hexadecane (DECHE-1,5,7,11-TOSU) 5; and 3,9-diethyl-3,9-bis(3-trimethylsilylpropyloxymethyl)-1,5,7,11-tetraoxaspiro[5.5]-undecane (DEBTMSPOM-1,5,7,11-TOSU) 6 was investigated. The photoreactivity assessments (n=1) were made using an EXFO Novacure light curing unit interfaced with a Perkin-Elmer Diamond DSC. The experimental conditions were as follows: 25° C.; N₂ atmosphere; 400-500 nm light; 3 mm quartz light guides; output: 500 mW/cm measured 15 mm from sample surface. The sample weights were 15-18 mg. Standard A1 pans were used. An empty pan was placed in the reference position. Irradiation time was for 10 minutes following a 1 minute equilibration. After the initial run, the sample was re-irradiated for an additional 10 minutes. This second curve was subtracted from the initial exotherm curve to zero out artifacts due to beginning and ending of irradiation, and to compensate for the heat capacity differences between the sample pan and empty reference pan. Integrations were from time t=1.1 (lamp shutter opened) min to 11.1 min (lamp shutter closed). Enthalpies of mixtures containing oxaspirocyclic monomers were measured and compared to the enthalpy calculated for a comparable formulation containing an inert diluent at the same addition level.

### Example 7(a)

### Monomers 1, 2, 3, 4, and 5

In this example, reaction mixtures containing 0 or 20 mol % of TOSU monomers 1, 2, 3, 4, and 5 in SIL-MIX were formulated with 4.1 wt % photoinitiator system (3 wt % PI; 1 wt % CQ; 0.1 wt % ED). Formulated mixtures were heated for 5 minutes on an oil bath at about 60° C. and stirred magnetically to aid dissolution of the photoinitiator system and inventive monomer. Formulations were prepared and stored away from ambient light. Mixtures were tested for photoreactivity the same day as prepared.

Enthalpies and exotherm peak maximum times (n=1) are given in Table 1. Formulations containing 1,5,7,11-tetraoxaspirocyclic monomers (1 (DEBAOM-1,5,7,11-TOSU), 2 (BTMSP-1,5,7,11-TOSU) and 5 (DECHE-1,5,7,11-TOSU)) had measured enthalpies 20% to 43% less than those calculated for a comparable mixture containing an inert diluent. Modeling and computational studies of 1,5,7,11-tetraoxaspirocyclic monomers indicates that that ring protonation and ring opening proceed via both exothermic and endothermic processes. The reduced enthalpies of mixtures containing these monomers may be a direct effect of TOSU ring opening polymerization that is necessary for possible volume expansion and stress reduction to take place. By contrast, formulations containing 2,4,8,10-tetraoxaspirocyclic monomers (3 (BAOM-2,4,8,10-TOSU) and 4 (BTMSE-2,4,8,10-TOSU)) had enthalpies 17% above those calculated for addition of an inert dihient. Computational studies of the polymerization reactions for these cyclic acetals have not been conducted. The coefficient of variation (CV) for replicate (n=3) enthalpy determinations (same mix; same day) in our laboratories is 1.8%.

TABLE 1
Photopolymerization enthalpies and exotherm peak maximum times

| | | | Exotherm |
|---|---|---|---|
| | | ΔH (experimental)/ | Peak |
| | Net Enthalpy | ΔH (calculated) | Maximum |
| Formulation | ΔH (J/g) | (%) | (sec) |
| SIL-MIX | −181^{b} | — | 14 |
| 1 DEBAOM-1,5,7,11^{a} | −116^{b} | 80 | 14 |
| 2 BTMSP-1,5,7,11^{a} | −78^{b} | 54 | 14 |
| 3 BAOM-2,4,8,10^{a} | −170^{b} | 117 | 15 |
| 4 BTMSE-2,4,8,10^{a} | −170^{b} | 117 | 17 |
| 5 DECHE-1,5,7,11^{a} | −82^{b} | 57 | 16 |
| INERT^{a} | −145^{c} | — | — |

^{a}20 mol % in SIL-MIX
^{b}experimental value
^{c}calculated value; assumes no enthalpy contribution from an inert diluent and 20% less oxirane groups available to react.

### Example 7(b)

### Monomers 1 and 6

In this example, enthalpies of mixtures containing 1 (DEBAOM-1,5,7,11-TOSU) or 6 (DEBTMSPOM-1,5,7,11-TOSU) were measured and compared to those calculated for comparable formulations containing an inert diluent in the silorane at the same addition levels. The effect of doubling the photoinitiator (PI) content from 3 wt % to 6 wt % was also determined for selected mixtures. As in Example 7(a) above, reaction mixtures (about 2 g) were formulated with 4.1 wt % photoinitiator system (3 wt % PI; 1 wt % CQ; 0.1 wt % ED) except where noted. Formulated mixtures were heated for 5 minutes on an oil bath @ 60° C. and stirred magnetically to dissolve the photoinitiator system and 6 (DEBTMSPOM-1,5,7,11-TOSU) when included. Formulations were prepared and stored away from ambient light and tested the same day as prepared.

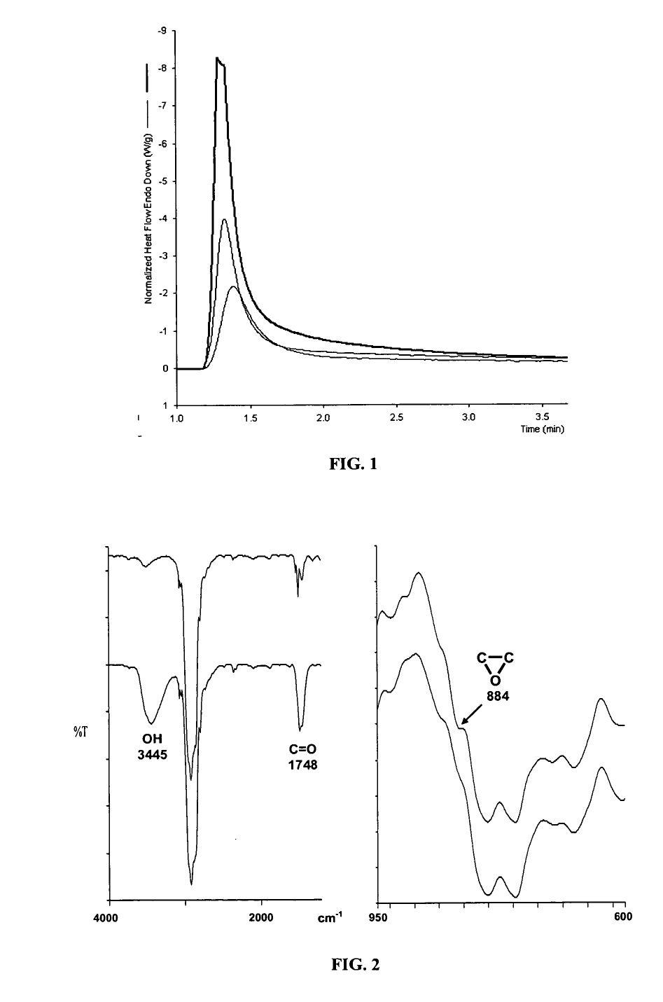

As shown in FIG. 1, all exothermal profiles for the photopolymerization of selected monomer compositions exhibited a rapid rise in the heat evolved up to a maximum and then a slower rate of decline. This behavior is characteristic of some network forming cationic polymer systems and is associated with the gel effect, which arises from an increase in the rate of diffusion controlled termination reactions, resulting from a steady increase in viscosity that reduces the mobility of growing polymer chains. Initially there is a rapid increase in the concentration of growing oligomer chains and propagation is favored over termination. The later decrease in the reaction rate may also be caused by the depletion of monomers in the system and the fact that the propagation reaction becomes diffusion controlled because of the reduction of monomer mobility as solidification is approached.

The results of the experimental and the calculated net enthalpy values for selected Silorane/TOSU reactant ratios and photoinitiator dosage levels are given in Table 2. Inspection and comparison of the net enthalpy values reveals the following information about the relative photoreactivity of the systems studied: (a) all test formulations containing a TOSU had ΔH values less than that calculated for a pure dilution effect, and (b) doubling the photoinitiator content (from 3 to 6 wt %) had only a minimal effect (a 5-7% increase in ΔH). Modeling and computational studies of 1,5,7,11-TOSUs indicate that ring protonation and ring opening proceed. via both exothermic and endothermic processes. The reduced enthalpies of mixtures containing TOSUs may be a direct effect of TOSU ring opening polymerization that is necessary for possible volume expansion and stress reduction to take place. Net photopolymerization exotherms for: (a) SIL-MIX and (b) SIL-MIX/(DEBTMSPOM-1,5,7,11-TOSU) 6 formulations at 90/10 and 25/75 mol/mol reactant ratios and 3% photoacid dosage level are shown in FIG. 1. The results indicate that SIL-MIX is the most reactive component in this series of formulations and that incorporation of 6 (DEBTMSPOM-1,5,7,11-TOSU) in SIL-MIX gave experimental ΔH values that were markedly less than calculated ΔH values: (a) for the 10% TOSU mix, the experimental ΔH was 71% of the calculated ΔH; and (b) for the 25% TOSU mix, the ΔH was 59% of the calculated ΔH. Incorporation of 20% 1 (DEBAOM-1,5,7,11-TOSU) in SIL-MIX yielded an experimental ΔH that was 81% of the calculated ΔH. Whereas, incorporation of 1 (DEBAOM-1,5,7,11-TOSU) at 50% in Ph-Sil gave an experimental value that was 75% of the calculated value. The coefficient of variation (CV) for replicate (n=3) enthalpy determinations (same mix; same day) in the laboratories is 1.8%.

TABLE 2
Photo DSC enthalpies of polymerization for siloranes with and without
tetraoxaspiroundecanes

| | |
|---|---|
| 3 wt % PI | 6 wt % PI |

| | ΔHₑₓₚ | ΔH_{calc} | ΔHₑₓₚ | ΔH_{calc} |
|---|---|---|---|---|
| Test Mixture | (J/g)^{a} | (J/g)^{b} | (J/g)^{a} | (J/g)^{b} |
| 100% SIL-MIX | −193 | — | 185 | — |
| 10% 6 | −124 | −174 | −127 | −166 |
| (DEBTMSPOM- | | | | |
| 1,5,7,11-TOSU) | | | | |
| 25% 6 | −86 | −145 | −87 | −139 |
| (DEBTMSPOM- | | | | |
| 1,5,7,11-TOSU) | | | | |
| 20% 1 (DEBAOM- | −124 | −154 | NT^{c} | NT^{c} |
| 1,5,7,11-TOSU) | | | | |
| 100% PH-SIL I | −208 | — | NT^{c} | NT^{c} |
| 50% 1 (DEBAOM- | −78 | −104 | NT^{c} | NT^{c} |
| 1,5,7,11-TOSU) | | | | |

^{a}Experimental enthalpy measured by integration of the area under the baseline-corrected, normalized photo polymerization exotherm profile curve from time t = 1.1 min to time t = 11.1 min.
^{b}Calculated enthalpy for addition of an inert diluent instead of 1 (DEBAOM-1, 5, 7, 11-TOSU) at 20 or 50 mol % or 6 (DEBTMSPOM-1, 5, 7, 11-TOSU) at 10, or 25 mol %. It assumes that all heat of reaction comes from the oxirane functionality and is based on measured experimental values for 100% silorane.
^{c}NT = Not tested.

### EXAMPLE 8

### Analysis of Oxirane Ring-Opening via Fourier Transform Infrared (“FTIR”) Spectroscopy

In this example, the oxirane ring-opening of monomers 1 (DEBAOM-1,5,7,11-TOSU) or 6 (DEBTMSPOM-1,5,7,11-TOSU) was investigated using FTIR. All FTIR spectra were acquired using a Perkin-Elmer BX II FTIR spectrophotometer. The identification of the location of the oxirane absorption band in the IR spectrum of Siloranes was achieved by methanolysis. A sample was dissolved in CH₂Cl₂ and exposed to CH₃0H in the presence of a catalytic amount of zinc tetrafluoroborate hydrate overnight. The mixture was evaporated onto a salt plate. An FTIR spectrum was acquired and compared to pre-exposure spectrum. There was a significant decrease in the oxirane absorption region at 882-886 cm⁻¹. This band was selected as the absorption to monitor for following the oxirane ring-opening reaction.

Analytical samples contained siloranes I, II, or SIL-MIX with and without 50 mol % of monomer 1 (DEBAOM-1,5,7,11-TOSU) or 6 (DEBTMSPOM-1,5,7,11-TOSU). A thin film was brushed onto a salt plate. Irradiation (10 minutes at 23 to 25° C. and R. H.=40-45%) was provided by a 3M XL2500 curing light positioned 1-cm above the sample surface. The light intensity was measured at 360 mW/cm² on the sample surface. The oxirane band absorption and an internal reference band absorption were assessed before and after irradiation. Oxirane conversion (alpha) was calculated according to equation (1) by Pan et al., Polym Int 2000, 49, 74.

$$alpha = \frac{{( {A}_{oxirane} / {A}_{ref} )}_{0} - {( {A}_{oxirane} / {A}_{ref} )}_{t}}{{( {A}_{oxirane} / {A}_{ref} )}_{0}} \times 100 \% \qquad ( 1 )$$

where subscripts 0 and t represent pre-irradiation and post-irradiation respectively.

The oxirane conversion results for siloranes with and without 50 mol % of 1 (DEBAOM-1,5,7,11-TOSU) or 6 (DEBTMSPOM-1,5,7,11-TOSU) irradiated as thin films on salt plates are shown in Table 3 below. The aromatic silane I has dioxirane functionality and is less viscous than the cyclosiloxane II which has tetraoxirane functionality. On a weight basis, there are approximately the same number of oxirane groups available as the molecular weight of I (370.60) is roughly half that of II (737.23). Viscosity differences may explain why the oxirane conversion for I (31%) was over twice that of II (13%).

Addition of the experimental monomer 6 (DEBTMSPOM-1,5,7,11-TOSU) (low melting solid) or the liquid unsaturated intermediate 1 (DEBAOM-1,5,7,11-TOSU) to the siloranes resulted in some analytical challenges. Fine structure in the 1400 to 800 cm⁻¹ region of the spectra of 1 (DEBAOM-1,5,7,11-TOSU) and 6 (DEBTMSPOM-1,5,7,11-TOSU) occluded some primary reference bands in the silorane spectra and partially occluded the primary oxirane absorption (882-884 cm⁻¹). Spectral regions of interest for the SIL-MIX and 6 (DEBTMSPOM-1,5,7,11-TOSU) reaction mixture before and after photopolymerization are shown in FIG. 2. The hydroxyl region peak at 3445 cm⁻¹ can result from opening of either the oxaspirocyclic rings of 6 (DEBTMSPOM-1,5,7,11-TOSU) or the oxirane rings of the siloranes. The carbonyl region peak at 1748 is typically associated with opening of the oxaspirocyclic rings in tetraoxaspiroundecanes to produce linear carbonate species. There was no evidence of reactivity at the double bond absorption peak (1647 cm⁻¹) in the unsaturated intermediate 1 (DEBAOM-1,5,7,11-TOSU) mixtures containing it and the siloranes. The band is small and difficult to quantitate. Oxygen inhibition of free radical polymerization at the unsaturated sites may have been a factor as the measurements were made in lab atmosphere. The increased oxirane conversion noted in mixtures containing 1 (DEBAOM-1,5,7,11-TOSU) may be due to a decrease in viscosity and corresponding increase in molecular mobility.

TABLE 3
Oxirane conversion of siloranes with and without
tetraoxaspiroundecanes

| | | Oxirane | |
|---|---|---|---|
| | Tetraoxaspiroundecane | Conversion^{b} | Reference |
| Silorane(s) | Comonomer | (%) | Band (cm⁻¹) |
| PH-SIL (I) | — | 31 | 1428 |
| PH-SIL (I) | 1 (DEBAOM-1,5,7,11- | 36 | 1455 |
| | TOSU) (50 mol %) | | |
| PH-SIL (I) | 6 (DEBTMSPOM-1,5,7,11- | 22 | 1428 |
| | TOSU) (50 mol %) | | |
| TET-SIL (II) | — | 13 | 1258 |
| TET-SIL (II) | 1 (DEBAOM-1,5,7,11- | 27 | 1455 |
| | TOSU) (50 mol %) | | |
| TET-SIL (II) | 6 (DEBTMSPOM-1,5,7,11- | 3 | 1228 |
| | TOSU) (50 mol %) | | |
| SIL-MIX^{a} | — | 28 | 1428 |
| SIL-MIX^{a} | 6 (DEBTMSPOM-1,5,7,11- | 22 | 1455 |
| | TOSU) (50 mol %) | | |

^{a}SIL-MIX is a 50/50 wt/wt mixture of I and II.
^{b}Based on the peak height of the 884-886 cm⁻¹ absorption band as compared to the indicated reference band before and after visible light photopolymerization.

### EXAMPLE 9

### Assessment of Oxaspirocyclic Ring Opening via NMR and FTIR

In this example, the oxaspirocylic ring-opening of monomer 6 (DEBTMSPOM-1,5,7,11-TOSU) was investigated using NMR and FTIR.

NMR Studies: NMR spectra were acquired using a Bruker Advance Ultrashield FT-NMR spectrometer. A reaction mixture consisting of 6 (DEBTMSPOM-1,5,7,11-TOSU) and the PI system was heated to 55-60° C. to liquefy and then allowed to cool to room temperature. A 300 mg sample was transferred to an 8 mm I.D.×8 mm H cylindrical glass mold and irradiated for 20 min (3 mm; 500 mW/cm²) using a 3M XL 2500 lamp. A small amount was transferred to an NMR tube, taken up in CDCl₃ and the ¹³C-NMR spectrum was acquired and compared to the pre-irradiation spectrum. The residual irradiated material was stored in the dark for 24 hr, resampled, and the NMR spectrum acquired and compared to the pre- and post-irradiation spectra.

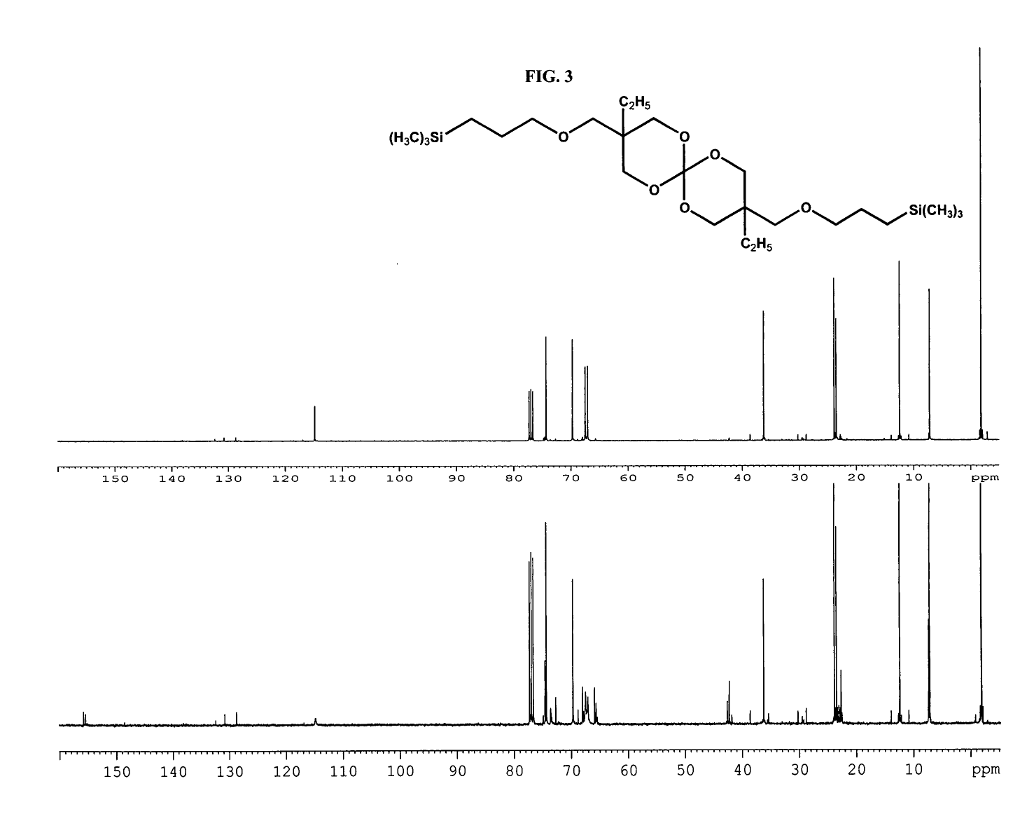

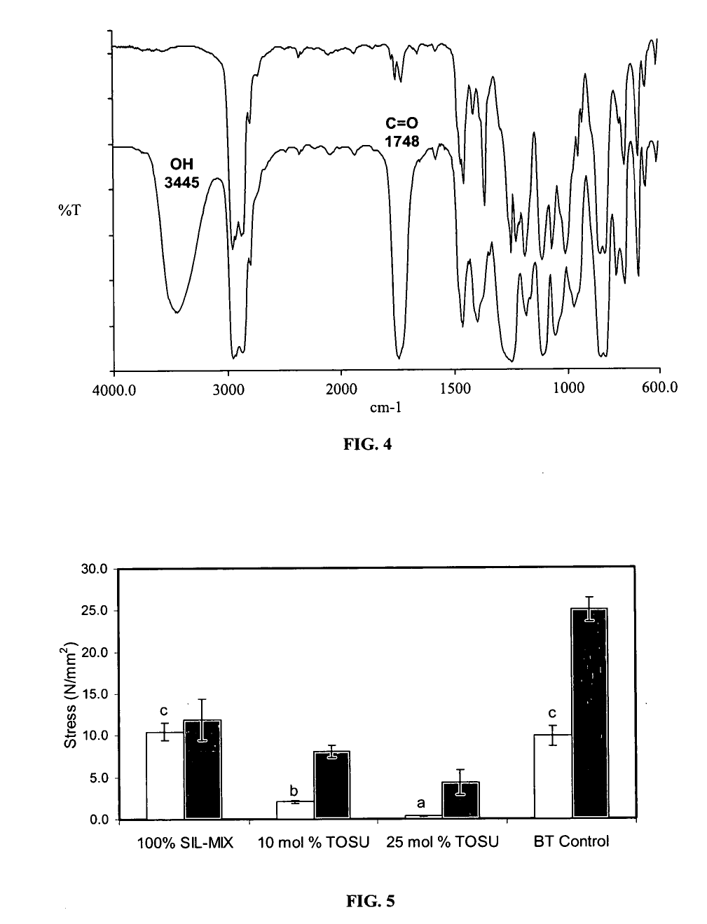

The ¹³C-NMR spectra of 6 (DEBTMSPOM-1,5,7,11-TOSU) immediately following irradiation (0 hour dark cure) and after 24 hour dark cure are shown in FIG. 3. No significant changes were noted in the NMR spectrum of 6 (DEBTMSPOM-1,5,7,11-TOSU) following irradiation (0 hour dark cure). The spiral carbon peak (114.8 ppm) was still intact, and there were no new peaks that would have indicated oxaspirocyclic ring opening (top spectrum). There were significant changes in the spectrum of the residual bulk polymerizate sample that was stored in the dark 24 hour and reanalyzed (bottom spectrum, FIG. 3). The spiral carbon peak (114.8 ppm) was greatly diminished and considerably broadened. The two new peaks ˜155 ppm thought to be due to linear carbonate C═O species and hydroxyl —C—OH peaks (41.8-42.6 ppm). Also, several differences in the 65-69 ppm region were noted. All of the changes were consistent with oxaspirocyclic ring opening to form oligomeric carbonate species.

FTIR studies: The FTIR spectra of the bulk polymerizate samples of 6 (DEBTMSPOM-1,5,7,11-TOSU) analyzed in the ¹³C NMR studies was acquired and compared to that of the pre-irradiation spectrum.

The FTIR spectrum of 6 (DEBTMSPOM-1,5,7,11-TOSU) after irradiation and NMR analysis (bottom; 0 hour dark cure) is compared to its pre-irradiation spectrum (top) in FIG. 7. There were new peaks (cm⁻¹) at: OH (3445); C═O (1748); and in the fingerprint region at 1463; 1397; 1058; 975; 790. The spectrum of the 24 hour dark cure NMR sample did not have any significant changes from the 0 hour dark cure sample. It is interesting that there were notable changes in the FTIR spectra of 6 (DEBTMSPOM-1,5,7,11-TOSU) shortly after irradiation, but that changes in the NMR spectrum were much slower to manifest.

### EXAMPLE 10

### Photopolymerization Stress Measurement

In this example, the photopolymerization stress of the monomers of the present invention was investigated. Stress generated during photopolymerization was measured (n=3) using an electromagnetic mechanical testing machine (Enduratec Model 3200, Bose Corp., Minnetonka, Minn.) adapted to be a tensilometer. See Feilzer et al., Dent. Mater. 1990, 6, 167; Alster et al., Biomater 1997, 18, 337. Briefly, two identical glass rods, 5 mm in diameter, were placed opposing one another and separated by 1 mm (C-factor=2.5). A displacement transducer (LVDT, Enduratec, 0.1 μm resolution, range ±1 mm) was mounted on one glass rod and was touching a plate attached to the opposing glass rod. The distance between the mounts on the opposing glass rods was about 9 mm (including the 1 mm separation between the rods). Samples placed between the glass rods were cured by irradiation (500 mW/cm²), while under LVDT displacement control. Load-displacement data were collected at 200 Hz for 30 mins. Loads were measured using an 1125 N load cell (0.03 N resolution). Measured displacements varied by ±1.0 μm during measurements. From the load-displacement data, peak loads were obtained and normalized by the original area to obtain the polymerization stresses.

### Example 10(a)

### Monomers 1-5

Photopolymerization stress results (n=3) for monomers 1, 2, 3, 4, and 5 are given in Table 4 below. An asterisk indicates significant difference from the methacrylate control (BT). ANOVA: F(6,14)=123.56; p<0.01; adjusted R²=0.974. Photopolymerization stress was reduced more than 90% for TOSU containing formulations, except 4 (40%). Further, the 2,4,8,10-TOSU isomers (3 and 4) were somewhat less effective stress reducers than their 1,5,7,11-TOSU counterparts.

TABLE 4
Polymerization stress and 24-h mechanical properties [mean(std. dev.)]
for SIL-MIX formulations as compared to a conventional methacrylate-based
resin control (BT).

| | Polymerization | Ultimate | Flexural | |
|---|---|---|---|---|
| | Stress | Strength | Elastic Modulus | Work of Fracture |
| Formulation | (N/mm²) | (MPa) | (GPa) | (kJ/m²) |
| BT | 13.37 (0.76) | 2.71 (0.19) | 106.3 (8.8) | 7.58 (2.05) |
| SIL-MIX | 11.50 (1.32) | 2.70 (0.24) | 100.4 (10.7) | 7.60 (3.74) |
| 1 DEBAOM- | 0.17 (0.06)* | 2.20 (0.21)* | 84.6 (8.4)* | 5.82 (2.02) |
| 1,5,7,11^{a} | | | | |
| 2 BTMSP- | 0.23 (0.06)* | 1.90 (0.14)* | 42.4 (8.5)* | 1.12 (0.42)* |
| 1,5,7,11^{a} | | | | |
| 3 BAOM- | 1.20 (0.17)* | 2.13 (0.21)* | 87.8 (6.7)* | 7.17 (1.58) |
| 2,4,8,10^{a} | | | | |
| 4 BTMSE- | 6.90 (1.76)* | 2.36 (0.30)* | 92.2 (13.5) | 5.63 (1.82) |
| 2,4,8,10^{a} | | | | |
| 5 DECHE- | 0.33 (0.15)* | 2.58 (0.18) | 96.0 (8.6) | 5.33 (1.09) |
| 1,5,7,11^{a} | | | | |

^{a}20 mol % in SIL-MIX
*indicates significant difference from the methacrylate resin control (BT)

### Example 10(b)

### Monomer 6

In a separate experiment, the polymerization stress of monomer 6 was investigated Results for SIL-MIX/6 (DEBTMSPOM-1,5,7,11-TOSU) mol/mol: Photopolymerization stress (N/mm²): 100/0=10.5(1.0); 90/10=2.1(0.2); 75/25=0.3(0.1); B/T=9.9(1.2). ANOVA: F(3,8)=131.42, p<0.01, adjusted R²=0.973. SIL-MIX and B/T were not significantly different. TOSU containing mixtures were significantly different than SIL-MIX or B/T and from each other. The mixtures containing 6 (DEBTMSPOM-1,5,7,11-TOSU) had polymerization stress values 80 to 96% less than SIL-MIX alone. The results are illustrated in FIG. 5.

### EXAMPLE 11

### Mechanical Properties Measurement

In this example, the elastic modulus, ultimate strength, and work of fracture were determined for the monomers of the present invention. These mechanical properties were determined (n=6) using 3-point bend tests to failure as per American Dental Association ADA Specification No. 27 for Dentistry: 2002—Polymer based filling, restorative and luting materials. ADA 27 and International Standard ISO 4049: 2000 Dentistry—Polymer-based filling restoration and luting materials. Briefly, specimens were manufactured in polyvinylsiloxane molds with dimensions of 2 mm×2 mm×25 mm (sample size: n=3 per group). The resin was injected into the mold and cured by irradiation (500 mW/cm²) followed by storage in the dark for 4 hours and 24 hours before mechanical tests were conducted. Three point bending tests were conducted using an electromagnetic mechanical testing machine (Enduratec Model 3200) with a 20-mm span and at a crosshead displacement rate of 0.5mm/ min at room temperature (25° C.). Load-displacement data were collected at 100 Hz. Loads were measured using a 225 N load cell with a resolution of 0.01 N (1500ASK, Enduratec) and displacement was measured at a resolution of 1 μm. Flexural modulus was determined using the initial slope of the load-displacement curves (from 10-25% of ultimate load values). Flexural ultimate strength was determined from the peak loads and work of fracture was determined from the area under the stress-strain curve.

### Example 11(a)

### Monomers 1-5

Results for mechanical properties testing (n=6) for monomers 1, 2, 3, 4, and 5 are given in the Table 4 in the preceding example. An asterisk indicates significant difference from the methacrylate control (BT). Ultimate strength—ANOVA: F(6,35)=29.10; p<0.01; adjusted R²=0.804. Flexural Modulus—ANOVA: F(6,35)=12.34; p<0.01; adjusted R²=0.624. Work of Fracture—F(6,35)=7.20; p<0.01; adjusted R²=0.477. Measured values (all mechanical properties) for SIL-MIX and SIL-MIX/5 were not significantly different than those for the methacrylate control (BT). SIL-MIX/2 had the lowest mechanical property values. SIL-MIX formulations containing oxaspirocyclic monomers 1, 2, 3, or 4 had significantly lower ultimate strength values than the methacrylate control (BT). SIL-MIX formulations containing tetraoxaspirocyclic monomers 1, 2, or 3 had significantly lower elastic modulus values than the methacrylate control (BT). The SIL-MIX formulation containing tetraoxaspirocyclic monomer 2 was the only one with significantly lower work of fracture values than the methacrylate control (BT). The test results suggest that incorporating oxirane functionality in the stress-reducing monomer can help maintain the mechanical properties of the cured resin system. The TOSU monomers showed the ability to greatly reduce the polymerization stress of Silorane-based matrix resins without proportional reduction in mechanical properties. The oxirane-substituted 5 (DECHE-1,5,7,11-TOSU) comonomer mixture had the best overall mechanical properties, comparable to Sil-Mix alone and the methacrylate control.

### Example 11(b)

### Monomer 6

The 4-hour/24-hour elastic modulus (GPa) values are presented in the following table. ANOVA for 4-hour results: F(3,8)=9.43, p<0.01, adjusted R²=0.697; for 24-h results: F(3,8)=36.91, p<0.01, adjusted R²=0.907. SIL-MIX and BIS-GMA/TEGDMA (“BT”) were not significantly different within the 4-hour group or within the 24-hour group. TOSU containing mixtures were significantly different than SIL-MIX or BT in both groups and from each other in the 24-h group. The 24-hour modulus values were 77% (10% TOSU) and 60% (25% TOSU) of those for SIL-MIX alone. The standard deviation is that of three replicates; within a column, the values with the same letter are not significantly different.

TABLE 5
Flexural elastic modulus (GPa)

| | 4-h Post Cure | 24-h Post Cure |
|---|---|---|
| Formulation | (GPa) | (GPa) |
| 100% SIL-MIX | 2.60 (0.41)^{b} | 3.13 (0.08)^{c} |
| 10 mol % TOSU | 1.61 (0.17)^{a} | 2.41 (0.24)^{b} |
| 25 mol % TOSU | 1.33 (0.18)^{a} | 1.87 (0.06)^{a} |
| 100% BT | 2.43 (0.51)^{b} | 3.00 (0.20)^{c} |

The 4-hour/24-hour flexural strength (MPa) values are given in the table below. ANOVA for 4-hour results: F(3,8)=7.93, p<0.01, adjusted R²=0.654; for 24-hour results: F(3,8)=9.22, p<0.01, adjusted R²=0.691. SIL-MIX and BT were not significantly different within the 4-hour group or within the 24-hour group. 25 mol % TOSU containing mixtures were significantly different than SIL-MIX or BT within both groups. TOSU containing mixtures were not significantly different from each other in either group. The 24-hour strength values were 85% (10% TOSU) and 60% (25% TOSU) of those for SIL-MIX alone. The standard deviation is that of three replicates; within a column, the values with the same letter are not significantly different.

TABLE 6
Flexural strength (MPa)

| | 4-hour Post Cure | 24-hour Post Cure |
|---|---|---|
| Formulation | (MPa) | (MPa) |
| 100% SIL-MIX | 97.23 (9.94)^{b} | 91.27 (4.65)^{b,c} |
| 10 mol % TOSU | 58.77 (19.08)^{a,b} | 76.90 (10.19)^{a,b} |
| 25 mol % TOSU | 30.90 (11.36)^{a} | 56.63 (11.11)^{a} |
| 100% BT | 96.13 (31.00)^{b} | 107.50 (20.75)^{c} |

The 4-hour/24-hour work of fracture (kJ/m²) values are shown in the table below. ANOVA for 4-hour results: F(3,8)=3.43, p>0.05, adjusted R²=0.398; for 24-hour results: F(3,8)=4.02, p>0.05, adjusted R²=0.451. SIL-MIX and B/T were not significantly different within the 4-hour group or within the 24-hour group. 25 mol % TOSU containing mixture values were not significantly different from each other (4 h and 24 h). The 10% TOSU containing mixture (24-hour post cure) was not significantly different than SIL-MIX alone. The 24-hour work of fracture values were 100% (10% TOSU) and 66% (25% TOSU) of those for SIL-MIX alone. The standard deviation is that of three replicates; within a column, the values with the same letter are not significantly different.

TABLE 7
Work of fracture (kJ/m²)

| | 4-hour Post Cure | 24-hour Post Cure |
|---|---|---|
| Formulation | (kJ/m²) | (kJ/m²) |
| 100% SIL-MIX | 3.87 (0.87)^{a} | 2.77 (0.12)^{a,b} |
| 10 mol % TOSU | 2.67 (1.25)^{a} | 3.07 (0.81)^{a,b} |
| 25 mol % TOSU | 0.73 (0.38)^{a} | 1.80 (0.87)^{a} |
| 100% BT | 4.80 (2.88)^{a} | 5.17 (2.14)^{b} |

Together, Examples 10 and 11 show that formulations containing 6 (DEBTMSPOM-1,5,7,11-TOSU) had polymerization stress values 80% (10 mol % TOSU) and 96% (25 mol % TOSU) less than SIL-MIX alone. Correspondingly, the 10 mol % 6 (DEBTMSPOM-1,5,7,11-TOSU) formulation had 24 hour modulus, strength, and work of fracture values that were 77%, 84%, and 100% respectively of those of SIL-MIX alone. The 25 mol % 6 (DEBTMSPOM-1,5,7,11-TOSU) formulation had 24 hour modulus, strength, and work of fracture values that were 60%, 60%, and 66% of those of SIL-MIX alone. The results suggest that a 10 mol % addition of 6 (DEBTMSPOM-1,5,7,11-TOSU) to SIL-MIX gives a dramatic reduction in photopolymerization stress with only a modest reduction in physical properties. For all mechanical properties, SIL-MIX (the silicon-oxirane based resin) was not significantly different than the BT methacrylate control.

From the foregoing it will be seen that this invention is one well adapted to attain all ends and objectives herein-above set forth, together with the other advantages which are obvious and which are inherent to the invention. Since many possible embodiments may be made of the invention without departing from the scope thereof, it is to be understood that all matters herein set forth or shown in the accompanying figures are to be interpreted as illustrative, and not in a limiting sense. While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A dental matrix resin comprising the mixture of
a tetraoxaspiro[5.5]undecane,
a polymerizable silorane, and
an initiator capable of initiating cationic polymerization of said resin.

2. The dental matrix resin of claim 1 wherein said initiator is a photoinitiator.

3. The resin of claim 2, wherein said photoinitiator is selected from the group consisting of (4-n-octyloxyphenyl)phenyliodonium hexafluoroantimonate, [4-(2-hydroxy-tetradecyloxyphenyl)]phenyliodonium hexafluoroantimonate, [4-1-methylethyl)-phenyl](4-methylphenyl)iodonium tetrakis(pentafluorophenyl)borate(1-), and combinations thereof.

4. The resin of claim 1, wherein said tetraoxspiro[5.5]undecane is selected from the group consisting of a 2,4,8,10-tetraoxaspiro[5.5]undecane or a 1,5,7,11-tetraoxaspiro[5.5]undecane,

5. The resin of claim 1 wherein said tetraoxspiro[5.5]undecane is selected from Formulas A1 and A2 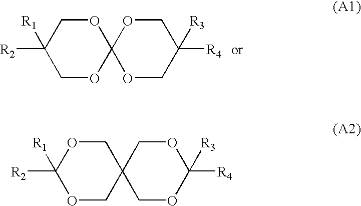
wherein R₁ and R₃ are independently is alkyl, aryl, aralkyl, or hydrogen; and
wherein R₂ and R₄ are independently alkenoxy, alkenoxyalkyl, or silicon-containing moiety selected from alkylsilyl, arylsilyl, arylalkylsilyl, alloxysilyl, aryloxysilyl, arylalkoxysilyl, alkylsiloxy, arylsiloxy, arylalkylsiloxy, alkoxysiloxy, aryloxysiloxy, arylalkoxysiloxy, alkylsilylalkyl, arylsilylalkyl, arylalkysilylalkyl, alkoxysilylalkyl, aryloxysilylalkyl, arylalkoxysilylalkyl, alkylsiloxyalkyl, arylsiloxyalkyl, arylalkylsiloxyalkyl, alkoxysiloxyalkyl, aryloxysiloxyalkyl, arylalkoxysiloxyalkyl, alkylsilylalkoxy, arylsilylalkoxy, arylalkylsilylalkoxy, alkoxysilylalkoxy, aryloxysilylalkoxy arylalkyloxysilylalkoxy, alkylsiloxyalkoxy, arylsiloxyalkoxy, arylalkylsiloxyalkoxy, alkoxysiloxyalkoxy, aryloxysiloxyalkoxy, and arylalkoxysiloxyalkoxy.

6. The resin of claim 5 wherein R₂ and R₄ are independently alkylsilylalkyl or alkylsiloxyalkyl.

7. The resin of claim 6 wherein R₂ and R₄ are independently alkylsilylalkyl selected from trimethylsilylpropyl, trimethylsilylethyl, triethylsilylpropyl, or triethylsilylethyl.

8. The resin of claim 1, wherein said silorane is selected from the group consisting of 2,4,6,8-tetramethyl-2,4,6,8-tetrakis-[2-(7-oxabicyclo[4.1.0]hept-3-yl)ethyl]-1,3,5,7-tetraoxa-2,4,6,8-tetrasilacyclooxtane II (TET-SIL).

9. The resin of claim 8 further comprising methylbis[2-(7-oxabicyclo[4.1.0]hept-3-yl)ethyl]phenylsilane I (PH-SIL).

10. The resin of claim 1, further comprising a photosensitizer.

11. The resin of claim 10, wherein said photosensitizer is selected from the group consisting of camphorquinone, 2-chlorothioxanthen-9-one, and combinations thereof.

12. The resin of claim 1, further comprising a reaction promoter.

13. The resin of claim 12, wherein said reaction promoter is selected from the group consisting of ethyl p-dimethylaminobenzoate, 4,4′-bis(diethylamino)benzophenone, and combinations thereof.

14. The resin of claim 1, wherein said resin comprises about 1 to 25 weight % of said tetraoxaspiro[5.5]undecane, about 75 to 99 weight % of said silorane, and about 1 to 4 weight % of said initiator.

15. The resin of claim 1 wherein said tetraoxaspiro[5,5]undecane is selected from the group consisting of 3,9-diethyl-3,9-bis(allyloxymethyl)-1,5,7,11-tetraoxaspiro[5.5]undecane (DEBAOM-1,5,7,11-TOSU) 1; 3,9-bis(3-trimethylsilylpropyl)-1,5,7,11-tetraoxaspiro[5.5]undecane (BTMSP-1,5,7,11-TOSU) 2; 3,9-bis(allyloxymethyl)-2,4,8,10-tetraoxaspiro[5.5]undecane (BAOM-2,4,8,10-TOSU) 3; 3,9-bis(2-trimethylsilylethyl)-2,3,8,10-tetraoxaspiro[5.5]undecane (BTMSE-2,4,8,10-TOSU) 4; 5,5-diethyl-19-oxadispiro[1,3-dioxane-2,2′-1,3-dioxane -5′,4″-bicyclo[4.1.0]heptane] (DECHE-1,5,7,11-TOSU) 5; and 3,9-diethyl-3,9-bis(3-trimethylsilylpropyloxymethyl)-1,5,7,11-tetraoxaspiro[5.5]-undecane (DEBTMSPOM-1,5,7,11-TOSU) 6.

16. Compounds according to the Formula A1: 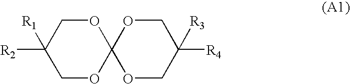
wherein R₁ and R₃ are independently is alkyl, aryl, aralkyl, or hydrogen; and
wherein R₂ and R₄ are independently alkenoxy, alkenoxyalkyl, or silicon-containing moiety selected from alkylsilyl, arylsilyl, arylalkylsilyl, alloxysilyl, aryloxysilyl, arylalkoxysilyl, alkylsiloxy, arylsiloxy, arylalkylsiloxy, alkoxysiloxy, aryloxysiloxy, arylalkoxysiloxy, alkylsilylalkyl, arylsilylalkyl, arylalkysilylalkyl, alkoxysilylalkyl, aryloxysilylalkyl, arylalkoxysilylalkyl, alkylsiloxyalkyl, arylsiloxyalkyl, arylalkylsiloxyalkyl, alkoxysiloxyalkyl, aryloxysiloxyalkyl, arylalkoxysiloxyalkyl, alkylsilylalkoxy, arylsilylalkoxy, arylalkylsilylalkoxy, alkoxysilylalkoxy, aryloxysilylalkoxy arylalkyloxysilylalkoxy, alkylsiloxyalkoxy, arylsiloxyalkoxy, arylalkylsiloxyalkoxy, alkoxysiloxyalkoxy, aryloxysiloxyalkoxy, and arylalkoxysiloxyalkoxy.

17. The compounds of claim 16 wherein R₂ and R₄ are independently alkenoxyalkyl or alkylsilylalkyl.

18. The compounds of claim 16 wherein R₂ and R₄ are independently
alkenyloxyalkyl selected from —(CH₂)ₙ—O—(CH₂)ₘ—CH══CH₂, and wherein m and n are independently 0, 1, 2, 3, 4; or
alkylsilylalkyl selected from trimethylsilylpropyl and trimethylsilylethyl.

19. Compounds according to Formula A2 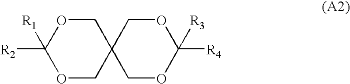
wherein R₁ and R₃ are independently is alkyl, aryl, aralkyl, or hydrogen; and
wherein R₂ and R₄ are independently alkenyl, alkenoxy, alkenoxyalkyl, or silicon-containing moiety selected from alkylsilyl, arylsilyl, arylalkylsilyl, alloxysilyl, aryloxysilyl, arylalkoxysilyl, alkylsiloxy, arylsiloxy, arylalkylsiloxy, alkoxysiloxy, aryloxysiloxy, arylalkoxysiloxy, alkylsilylalkyl, arylsilylalkyl, arylalkysilylalkyl, alkoxysilylalkyl, aryloxysilylalkyl, arylalkoxysilylalkyl, alkylsiloxyalkyl, arylsiloxyalkyl, arylalkylsiloxyalkyl, alkoxysiloxyalkyl, aryloxysiloxyalkyl, arylalkoxysiloxyalkyl, alkylsilylalkoxy, arylsilylalkoxy, arylalkylsilylalkoxy, alkoxysilylalkoxy, aryloxysilylalkoxy arylalkyloxysilylalkoxy, alkylsiloxyalkoxy, arylsiloxyalkoxy, arylalkylsiloxyalkoxy, alkoxysiloxyalkoxy, aryloxysiloxyalkoxy, and arylalkoxysiloxyalkoxy.

20. The compounds of claim 19 wherein R₂ and R₄ are independently alkenyl, alkenoxyalkyl, and alkylsilylalkyl.

21. The compounds of claim 19 wherein R₂ and R₄ are independently
alkenyl selected the group consisting of —(CH₂)ₙ—CH══CH₂, and wherein n is independently 0, 1, 2, 3, 4; or
alkenyloxyalkyl selected from —(CH₂)ₙ—O—(CH2)ₘ-CH══CH₂, and wherein m and n are independently 0, 1, 2, 3, 4; or
alkylsilylalkyl selected from trimethylsilylpropyl and trimethylsilylethyl.

22. A tetraoxaspiro[5,5]undecane selected from the group consisting of selected from the group consisting of 3,9-diethyl-3,9-bis(allyloxymethyl)-1,5,7,11-tetraoxaspiro[5.5]undecane (DEBAOM-1,5,7,11-TOSU) 1; 3,9-bis(3-trimethylsilylpropyl)-1,5,7,11-tetraoxaspiro[5.5]undecane (BTMSP-1,5,7,11-TOSU) 2; 3,9-bis(allyloxymethyl)-2,4,8,10-tetraoxaspiro[5.5]undecane (BAOM-2,4,8,10-TOSU) 3; 3,9-bis(2-trimethylsilylethyl)-2,3,8,10-tetraoxaspiro[5.5]undecane (BTMSE-2,4,8,10-TOSU) 4; and 3,9-diethyl-3,9-bis(3-trimethylsilylpropyloxymethyl)-1,5,7,11-tetraoxaspiro[5.5]-undecane (DEBTMSPOM-1,5,7,11-TOSU) 6.
